(19) United States
(12) Patent Application Publication
(10) Pub. No.: US 2021/0049578 A1
(43) Pub. Date: Feb. 18, 2021

(54) System, Method, and Computer Program Product for Tracking Data Associated with an Account to Determine a Score

(71) Applicant: Visa International Service Association, San Francisco, CA (US)

(72) Inventors: Shehla Mehdia Ghori, Leander, TX (US); Namratha Shivashankar, Austin, TX (US); Sivasagar Reddy Palagiri, Georgetown, TX (US)

(21) Appl. No.: 16/541,259

(22) Filed: Aug. 15, 2019

(51) Int. Cl. G06Q 20/24; G06Q 20/40; G06Q 40/02

(52) U.S. Cl. CPC G06Q 20/24; G06Q 40/025; G06Q 20/405

(57) ABSTRACT

Provided are computer-implemented methods for tracking data associated with an account to determine a score. Computer-implemented methods may include receiving transaction data associated with at least one transaction involving a merchant, determining a credit score of the merchant based on the at least one transaction involving the merchant, receiving transaction request data associated with an instant transaction involving the merchant and a supplier, transmitting an underwriting request message comprising score data associated with the credit score of the merchant and the transaction request data associated with the instant transaction, receiving an underwriting response message comprising an indication as to whether the instant transaction is underwritten by an underwriting institution, and transmitting transaction response data associated with a transaction response including an indication as to whether the instant transaction is underwritten. Systems and computer program products are also provided.

### BACKGROUND

### 1. Field

This disclosure relates generally to determining scores for accounts and, in some non-limiting aspects or embodiments, to systems, methods, and computer program products for tracking data associated with an account to determine a score.

### 2. Technical Considerations

Merchants may place orders for goods and/or services needed to prepare products (e.g., goods and/or services sold by the merchants) to bring the products to market. When purchasing the goods and/or services, the merchants may rely on funds supplied from an issuer institution (e.g., a bank) to satisfy the transaction, included either from a line of credit or from funds of the merchant maintained by the issuer institution. During a transaction, the issuer institution may transmit an indication to the supplier institution via an acquirer institution that funds of an account associated with merchant are available to satisfy the transaction. However, in such cases, the merchant may be limited to the amount of funds available from the account associated with the merchant and/or the amount of funds available from the line of credit and, as a result, may not have access to funds to complete some transactions. Additionally, the issuer institution extending the funds may not be able to adjust the line of credit for a given transaction and, as a result, may be unable to authorize a purchase that exceeds the amount of funds available from the line of credit. Thus, the disclosure of systems, methods, and computer program products that enable the tracking of data associated with an account to determine a score is desirable.

### SUMMARY

Accordingly, disclosed are systems, methods, and computer program products for tracking data associated with an account to determine a score.

According to some non-limiting aspects or embodiments, provided is a computer-implemented method, including: receiving, with at least one processor, transaction data associated with at least one transaction involving a merchant associated with a merchant system and at least one supplier associated with at least one supplier system, determining, with at least one processor, a credit score of the merchant based on the at least one transaction involving the merchant and the at least one supplier, receiving, with at least one processor, transaction request data associated with an instant transaction involving the merchant associated with the merchant system and a supplier associated with a supplier system, transmitting, with at least one processor, an underwriting request message including score data associated with the credit score of the merchant and the transaction request data associated with the instant transaction to at least one underwriting system associated with at least one underwriting institution, receiving, with at least one processor, an underwriting response message including an indication as to whether the instant transaction is underwritten by an underwriting institution associated with an underwriting system, and transmitting, with at least one processor, transaction response data associated with a transaction response to the supplier system, the transaction response including an indication as to whether the instant transaction is underwritten.

In some non-limiting aspects or embodiments, the computer-implemented method may include determining, with at least one processor, that insufficient funds are available from an account associated with the merchant that is maintained by an issuer system associated with an issuer institution based on receiving the transaction request data associated with the instant transaction, and generating, with at least one processor, the underwriting request message based on determining that insufficient funds are available from the account associated with the merchant that is maintained by the issuer system.

According to some non-limiting aspects or embodiments, the computer-implemented method may include determining, with at least one processor, that the transaction request data associated with the instant transaction indicates that the merchant is requesting the transaction be underwritten by an underwriting institution, and generating, with at least one processor, the underwriting request message based on determining that the transaction request data associated with the instant transaction indicates that the merchant is requesting the transaction be underwritten by an underwriting institution.

In some non-limiting aspects or embodiments, receiving the underwriting response message including the indication as to whether the instant transaction is underwritten by the underwriting institution associated with an underwriting system may include receiving a plurality of underwriting response messages from a plurality of underwriting systems associated with a plurality of underwriting institutions, the underwriting response messages including underwriting data associated with the instant transaction, and selecting an underwriting system associated with an underwriting institution to underwrite the instant transaction based on data included in the underwriting response messages.

According to some non-limiting aspects or embodiments, selecting the underwriting system associated with the underwriting institution to underwrite the instant transaction based on data included in the underwriting response messages may include comparing the data included in the underwriting response messages received from the plurality of underwriting systems, and selecting the underwriting system associated with a value for underwriting the instant transaction that is lower than values for underwriting the instant transaction associated with the other underwriting institutions from among the plurality of underwriting institutions.

In some non-limiting aspects or embodiments, selecting the underwriting system associated with the underwriting institution to underwrite the instant transaction based on data included in the underwriting response messages may include comparing the data included in the underwriting response messages received from the plurality of underwriting systems, and selecting the underwriting system associated with a period of time which may pass before satisfaction of the transaction by the underwriting institution is permitted, wherein the period of time is greater than periods of time which may pass associated with the other underwriting institutions from among the plurality of underwriting institutions.

According to some non-limiting aspects or embodiments, the computer-implemented method may further include receiving, with at least one processor, a request message including a request for transaction identification data associated with an identifier of the instant transaction from the supplier system involved in the instant transaction, generating, with at least one processor, the transaction identification data associated with the identifier of the instant transaction, and transmitting, with at least one processor, the transaction identification data associated with the identifier of the instant transaction to the supplier system involved in the instant transaction.

In some non-limiting aspects or embodiments, the computer-implemented method may further include receiving, with at least one processor, a request message including a request for transaction identification data associated with an identifier of the instant transaction from the supplier system involved in the instant transaction, generating, with at least one processor, the transaction identification data associated with the identifier of the instant transaction, and transmitting, with at least one processor, the transaction identification data associated with the identifier of the instant transaction to the merchant system involved in the instant transaction.

According to some non-limiting aspects or embodiments, transmitting the transaction identification data associated with the identifier of the instant transaction to the merchant system involved in the instant transaction may include transmitting the transaction identification data associated with the identifier of the instant transaction via a data connection or an SMS connection.

In some non-limiting aspects or embodiments, transmitting the transaction identification data associated with the identifier of the instant transaction to the merchant system involved in the instant transaction may include transmitting the transaction identification data associated with the identifier of the instant transaction via an online portal associated with a webpage of a website.

According to some non-limiting aspects or embodiments, the computer-implemented method may include receiving, with at least one processor, the transaction identification data associated with the identifier of the instant transaction from the merchant system, transmitting, with at least one processor, an authorization request message to an issuer system based on receiving the transaction identification data associated with the identifier of the instant transaction, receiving, with at least one processor, an authorization response message from the issuer system, the authorization response message including an indication as to whether the transaction is approved, and transmitting, with at least one processor, a confirmation message including an indication as to whether the instant transaction was successfully processed based on the indication as to whether the transaction is approved included in the authorization response message.

In some non-limiting aspects or embodiments, generating the transaction identification data associated with the identifier of the instant transaction may include generating, with at least one processor, the transaction identification data associated with the identifier of the instant transaction, the identifier including a computer-readable image associated with an account of the merchant maintained by the underwriting system.

According to some non-limiting aspects or embodiments, receiving, with at least one processor, the transaction identification data associated with the identifier of the instant transaction from the merchant system, and receiving, with at least one processor, image data associated with an image received by the merchant system of a computer-readable image associated with an account of the merchant maintained by the underwriting system.

In some non-limiting aspects or embodiments, determining the score data associated with the credit score of the merchant based on the at least one transaction involving the merchant and the at least one supplier may include receiving merchant data associated with the merchant, and receiving local factor data associated with one or more local factors. Determining the credit score of the merchant may include determining the credit score of the merchant based on the merchant data associated with the merchant and the local factor data associated with the one or more local factors.

According to some non-limiting aspects or embodiments, determining the score data associated with the credit score of the merchant based on the at least one transaction involving the merchant and the at least one supplier may include determining local weather data associated with an indication as to a state of the weather associated with a location of the merchant, and generating updated score data associated with an updated credit score based at least partially on the local weather data. The underwriting request message may include the updated score data associated with the updated credit score.

In some non-limiting aspects or embodiments, determining the credit score of the merchant based on the at least one transaction involving the merchant and the at least one supplier may include determining local transaction data associated with one or more transactions that occur within a predetermined distance from a location associated with the merchant, and generating updated score data associated with an updated credit score based at least partially on the one or more transactions that occur within a predetermined distance from the location associated with the merchant. The underwriting request message may include the updated score data associated with the updated credit score.

According to some non-limiting aspects or embodiments, determining local transaction data associated with one or more transactions that occur within a predetermined distance from the location associated with the merchant may include receiving transaction data associated with one or more transactions involving another merchant associated with another merchant system and the at least one supplier associated with the at least one supplier system, and selecting transactions from the one or more transactions involving the another merchant associated with another merchant system and the at least one supplier associated with the at least one supplier system based on location data associated with the another merchant.

In some non-limiting aspects or embodiments, when selecting transactions from the one or more transactions involving the another merchant associated with another merchant system and the at least one supplier associated with the at least one supplier system based on location data associated with the another merchant, the transactions that are selected include transactions associated with the another merchant that is located within a predetermined distance from the location of the merchant involved in the instant transaction.

According to some non-limiting aspects or embodiments, provided is a system, including at least one processor programmed or configured to receive transaction data associated with at least one transaction involving a merchant associated with a merchant system and at least one supplier associated with at least one supplier system, determine a credit score of the merchant based on the at least one transaction involving the merchant and the at least one supplier, receive transaction request data associated with an instant transaction involving the merchant associated with the merchant system and a supplier associated with a supplier system, transmit an underwriting request message including score data associated with the credit score of the merchant and the transaction request data associated with the instant transaction to at least one underwriting system associated with at least one underwriting institution, receive an underwriting response message including an indication as to whether the instant transaction is underwritten by an underwriting institution associated with an underwriting system, and transmit transaction response data associated with a transaction response to the supplier system, the transaction response message including an indication as to whether the instant transaction is underwritten.

In some non-limiting aspects or embodiments, the at least one processor may be further programmed or configured to determine that insufficient funds are available from an account associated with the merchant that is maintained by an issuer system associated with an issuer institution based on receiving the transaction request data associated with the instant transaction, and generate the underwriting request message based on determining that insufficient funds are available from the account associated with the merchant that is maintained by the issuer system.

According to some non-limiting aspects or embodiments, the at least one processor may be further programmed or configured to, determine that the transaction request data associated with the instant transaction indicates that the merchant is requesting the transaction be underwritten by an underwriting institution, and generate the underwriting request message based on determining that the transaction request data associated with the instant transaction indicates that the merchant is requesting the transaction be underwritten by an underwriting institution.

In some non-limiting aspects or embodiments, when receiving the underwriting response message including the indication as to whether the instant transaction is underwritten by the underwriting institution associated with an underwriting system, the at least one processor may be programmed or configured to receive a plurality of underwriting response messages from a plurality of underwriting systems associated with a plurality of underwriting institutions, the underwriting response messages including underwriting data associated with the instant transaction, and select an underwriting system associated with an underwriting institution to underwrite the instant transaction based on data included in the underwriting response messages.

According to some non-limiting aspects or embodiments, when selecting the underwriting system associated with the underwriting institution to underwrite the instant transaction based on data included in the underwriting response messages, the at least one processor may be programmed or configured to compare the data included in the underwriting response messages received from the plurality of underwriting systems, and select the underwriting system associated with a value for underwriting the instant transaction that is lower than values for underwriting the instant transaction associated with the other underwriting institutions from among the plurality of underwriting institutions.

In some non-limiting aspects or embodiments, when selecting the underwriting system associated with the underwriting institution to underwrite the instant transaction based on data included in the underwriting response messages, the at least one processor may be programmed or configured to compare the data included in the underwriting response messages received from the plurality of underwriting systems, and select the underwriting system associated with a period of time which may pass before satisfaction of the transaction by the underwriting institution is permitted, wherein the period of time is greater than periods of time which may pass associated with the other underwriting institutions from among the plurality of underwriting institutions.

According to some non-limiting aspects or embodiments, the at least one processor may be further programmed or configured to receive a request message including a request for transaction identification data associated with an identifier of the instant transaction from the supplier system involved in the instant transaction, generate the transaction identification data associated with the identifier of the instant transaction, and transmit the transaction identification data associated with the identifier of the instant transaction to the supplier system involved in the instant transaction.

In some non-limiting aspects or embodiments, the at least one processor may be further programmed or configured to: receive a request message including a request for transaction identification data associated with an identifier of the instant transaction from the supplier system involved in the instant transaction, generate the transaction identification data associated with the identifier of the instant transaction, and transmit the transaction identification data associated with the identifier of the instant transaction to the merchant system involved in the instant transaction.

According to some non-limiting aspects or embodiments, when transmitting the transaction identification data associated with the identifier of the instant transaction to the merchant system involved in the instant transaction, the at least one processor may be programmed or configured to transmit the transaction identification data associated with the identifier of the instant transaction via a data connection or an SMS connection.

In some non-limiting aspects or embodiments, when transmitting the transaction identification data associated with the identifier of the instant transaction to the merchant system involved in the instant transaction, the at least one processor may be programmed or configured to transmit the transaction identification data associated with the identifier of the instant transaction via an online portal associated with a webpage of a website.

According to some non-limiting aspects or embodiments, the at least one processor may be further programmed or configured to receive the transaction identification data associated with the identifier of the instant transaction from the merchant system, transmit an authorization request message to an issuer system based on receiving the transaction identification data associated with the identifier of the instant transaction, receive an authorization response message from the issuer system, the authorization response message including an indication as to whether the transaction is approved, and transmit a confirmation message including an indication as to whether the instant transaction was successfully processed based on the indication as to whether the transaction is approved included in the authorization response message.

In some non-limiting aspects or embodiments, when generating the transaction identification data associated with the identifier of the instant transaction, the at least one processor may be programmed or configured to generate the transaction identification data associated with the identifier of the instant transaction, the identifier including a computer-readable image associated with an account of the merchant maintained by the underwriting system.

According to some non-limiting aspects or embodiments, the at least one processor may be further programmed or configured to receive the transaction identification data associated with the identifier of the instant transaction from the merchant system, and receive image data associated with an image received by the merchant system of a computer-readable image associated with an account of the merchant maintained by the underwriting system.

In some non-limiting aspects or embodiments, when determining the score data associated with the credit score of the merchant based on the at least one transaction involving the merchant and the at least one supplier, the at least one processor may be programmed or configured to receive merchant data associated with the merchant, and receive local factor data associated with one or more local factors. When determining the credit score of the merchant, the at least one processor may be programmed or configured to determine the credit score of the merchant based on the merchant data associated with the merchant and the local factor data associated with the one or more local factors.

According to some non-limiting aspects or embodiments, when determining the score data associated with the credit score of the merchant based on the at least one transaction involving the merchant and the at least one supplier, the at least one processor may be programmed or configured to determine local weather data associated with an indication as to a state of the weather associated with a location of the merchant, and generate updated score data associated with an updated credit score based at least partially on the local weather data. The underwriting request message may include the updated score data associated with the updated credit score.

In some non-limiting aspects or embodiments, when determining the credit score of the merchant based on the at least one transaction involving the merchant and the at least one supplier, the at least one processor may be programmed or configured to determine local transaction data associated with one or more transactions that occur within a predetermined distance from a location associated with the merchant, and generate updated score data associated with an updated credit score based at least partially on the one or more transactions that occur within a predetermined distance from the location associated with the merchant. The underwriting request message may include the updated score data associated with the updated credit score.

According to some non-limiting aspects or embodiments, when determining local transaction data associated with one or more transactions that occur within a predetermined distance from the location associated with the merchant, the at least one processor may be programmed or configured to receive transaction data associated with one or more transactions involving another merchant associated with another merchant system and the at least one supplier associated with the at least one supplier system, and select transactions from the one or more transactions involving the another merchant associated with another merchant system and the at least one supplier associated with the at least one supplier system based on location data associated with the another merchant.

In some non-limiting aspects or embodiments, when selecting transactions from the one or more transactions involving the another merchant associated with another merchant system and the at least one supplier associated with the at least one supplier system based on location data associated with the another merchant, the transactions that are selected may include transactions associated with the another merchant that may be located within a predetermined distance from the location of the merchant involved in the instant transaction.

According to some non-limiting aspects or embodiments, provided is a computer program product including at least one non-transitory computer-readable medium including one or more instructions that, when executed by at least one processor, cause the at least one processor to receive transaction data associated with at least one transaction involving a merchant associated with a merchant system and at least one supplier associated with at least one supplier system, determine a credit score of the merchant based on the at least one transaction involving the merchant and the at least one supplier, receive transaction request data associated with an instant transaction involving the merchant associated with the merchant system and a supplier associated with a supplier system, transmit an underwriting request message including score data associated with the credit score of the merchant and the transaction request data associated with the instant transaction to at least one underwriting system associated with at least one underwriting institution, receive an underwriting response message including an indication as to whether the instant transaction may be underwritten by an underwriting institution associated with an underwriting system, and transmit transaction response data associated with a transaction response to the supplier system, the transaction response message including an indication as to whether the instant transaction is underwritten.

In some non-limiting aspects or embodiments, the one or more instructions further cause the at least one processor to determine that insufficient funds are available from an account associated with the merchant that may be maintained by an issuer system associated with an issuer institution based on receiving the transaction request data associated with the instant transaction, and generate the underwriting request message based on determining that insufficient funds are available from the account associated with the merchant that may be maintained by the issuer system.

According to some non-limiting aspects or embodiments, the one or more instructions may further cause the at least one processor to determine that the transaction request data associated with the instant transaction indicates that the merchant is requesting the transaction be underwritten by an underwriting institution, and generate the underwriting request message based on determining that the transaction request data associated with the instant transaction indicates that the merchant is requesting the transaction be underwritten by an underwriting institution.

In some non-limiting aspects or embodiments, the one or more instructions that cause the at least one processor to receive the underwriting response message including the indication as to whether the instant transaction is underwritten by the underwriting institution associated with an underwriting system, cause the at least one processor to receive a plurality of underwriting response messages from a plurality of underwriting systems associated with a plurality of underwriting institutions, the underwriting response messages including underwriting data associated with the instant transaction, and select an underwriting system associated with an underwriting institution to underwrite the instant transaction based on data included in the underwriting response messages.

According to some non-limiting aspects or embodiments, the one or more instructions that cause the at least one processor to select the underwriting system associated with the underwriting institution to underwrite the instant transaction based on data included in the underwriting response messages, cause the at least one processor to compare the data included in the underwriting response messages received from the plurality of underwriting systems, and select the underwriting system associated with a value for underwriting the instant transaction that may be lower than values for underwriting the instant transaction associated with the other underwriting institutions from among the plurality of underwriting institutions.

In some non-limiting aspects or embodiments, the one or more instructions that cause the at least one processor to select the underwriting system associated with the underwriting institution to underwrite the instant transaction based on data included in the underwriting response messages may cause the at least one processor to compare the data included in the underwriting response messages received from the plurality of underwriting systems, and select the underwriting system associated with a period of time which may pass before satisfaction of the transaction by the underwriting institution may be permitted, wherein the period of time may be greater than periods of time which may pass associated with the other underwriting institutions from among the plurality of underwriting institutions.

According to some non-limiting aspects or embodiments, the one or more instructions further cause the at least one processor to receive a request message including a request for transaction identification data associated with an identifier of the instant transaction from the supplier system involved in the instant transaction, generate the transaction identification data associated with the identifier of the instant transaction, and transmit the transaction identification data associated with the identifier of the instant transaction to the supplier system involved in the instant transaction.

In some non-limiting aspects or embodiments, the one or more instructions may further cause the at least one processor to receive a request message including a request for transaction identification data associated with an identifier of the instant transaction from the supplier system involved in the instant transaction, generate the transaction identification data associated with the identifier of the instant transaction, and transmit the transaction identification data associated with the identifier of the instant transaction to the merchant system involved in the instant transaction.

According to some non-limiting aspects or embodiments, the one or more instructions that cause the at least one processor to transmit the transaction identification data associated with the identifier of the instant transaction to the merchant system involved in the instant transaction may cause the at least one processor to transmit the transaction identification data associated with the identifier of the instant transaction via a data connection or an SMS connection.

In some non-limiting aspects or embodiments, the one or more instructions that cause the at least one processor to transmit the transaction identification data associated with the identifier of the instant transaction to the merchant system involved in the instant transaction may cause the at least one processor to transmit the transaction identification data associated with the identifier of the instant transaction via an online portal associated with a webpage of a website.

According to some non-limiting aspects or embodiments, the one or more instructions may further cause the at least one processor to receive the transaction identification data associated with the identifier of the instant transaction from the merchant system, transmit an authorization request message to an issuer system based on receiving the transaction identification data associated with the identifier of the instant transaction, receive an authorization response message from the issuer system, the authorization response message including an indication as to whether the transaction is approved, and transmit a confirmation message including an indication as to whether the instant transaction was successfully processed based on the indication as to whether the transaction is approved included in the authorization response message.

In some non-limiting aspects or embodiments, the one or more instructions that cause the at least one processor to generate the transaction identification data associated with the identifier of the instant transaction may cause the at least one processor to generate the transaction identification data associated with the identifier of the instant transaction, the identifier including a computer-readable image associated with an account of the merchant maintained by the underwriting system.

According to some non-limiting aspects or embodiments, the one or more instructions may further cause the at least one processor to receive the transaction identification data associated with the identifier of the instant transaction from the merchant system, and receive image data associated with an image received by the merchant system of a computer-readable image associated with an account of the merchant maintained by the underwriting system.

In some non-limiting aspects or embodiments, the one or more instructions that cause the at least one processor to determine the score data associated with the credit score of the merchant based on the at least one transaction involving the merchant and the at least one supplier may cause the at least one processor to receive merchant data associated with the merchant, and receive local factor data associated with one or more local factors. When determining the credit score of the merchant, the at least one processor may be programmed or configured to determine the credit score of the merchant based on the merchant data associated with the merchant and the local factor data associated with the one or more local factors.

According to some non-limiting aspects or embodiments, the one or more instructions that cause the at least one processor to determine the score data associated with the credit score of the merchant based on the at least one transaction involving the merchant and the at least one supplier may cause the at least one processor to determine local weather data associated with an indication as to a state of the weather associated with a location of the merchant, and generate updated score data associated with an updated credit score based at least partially on the local weather data. The underwriting request message may include the updated score data associated with the updated credit score.

In some non-limiting aspects or embodiments, the one or more instructions that cause the at least one processor to determine the credit score of the merchant based on the at least one transaction involving the merchant and the at least one supplier may cause the at least one processor to determine local transaction data associated with one or more transactions that occur within a predetermined distance from a location associated with the merchant, and generate updated score data associated with an updated credit score based at least partially on the one or more transactions that occur within a predetermined distance from the location associated with the merchant. The underwriting request message may include the updated score data associated with the updated credit score.

According to some non-limiting aspects or embodiments, the one or more instructions that cause the at least one processor to determine local transaction data associated with one or more transactions that occur within a predetermined distance from the location associated with the merchant, cause the at least one processor to receive transaction data associated with one or more transactions involving another merchant associated with another merchant system and the at least one supplier associated with the at least one supplier system, and select transactions from the one or more transactions involving the another merchant associated with another merchant system and the at least one supplier associated with the at least one supplier system based on location data associated with the another merchant.

In some non-limiting aspects or embodiments, the one or more instructions may cause the at least one processor to select transactions from the one or more transactions involving the another merchant associated with another merchant system and the at least one supplier associated with the at least one supplier system based on location data associated with the another merchant, the transactions selected including transactions associated with the another merchant that may be located within a predetermined distance from the location of the merchant involved in the instant transaction.

Further non-limiting aspects or embodiments are set forth in the following numbered clauses:

Clause 1: A computer-implemented method, comprising: receiving, with at least one processor, transaction data associated with at least one transaction involving a merchant associated with a merchant system and at least one supplier associated with at least one supplier system; determining, with at least one processor, a credit score of the merchant based on the at least one transaction involving the merchant and the at least one supplier; receiving, with at least one processor, transaction request data associated with an instant transaction involving the merchant associated with the merchant system and a supplier associated with a supplier system; transmitting, with at least one processor, an underwriting request message comprising score data associated with the credit score of the merchant and the transaction request data associated with the instant transaction to at least one underwriting system associated with at least one underwriting institution; receiving, with at least one processor, an underwriting response message comprising an indication as to whether the instant transaction is underwritten by an underwriting institution associated with an underwriting system; and transmitting, with at least one processor, transaction response data associated with a transaction response to the supplier system, the transaction response comprising an indication as to whether the instant transaction is underwritten.

Clause 2: The computer-implemented method of clause 1, further comprising: determining, with at least one processor, that insufficient funds are available from an account associated with the merchant that is maintained by an issuer system associated with an issuer institution based on receiving the transaction request data associated with the instant transaction; and generating, with at least one processor, the underwriting request message based on determining that insufficient funds are available from the account associated with the merchant that is maintained by the issuer system.

Clause 3: The computer-implemented method of clauses 1 or 2, further comprising: determining, with at least one processor, that the transaction request data associated with the instant transaction indicates that the merchant is requesting the transaction be underwritten by an underwriting institution; and generating, with at least one processor, the underwriting request message based on determining that the transaction request data associated with the instant transaction indicates that the merchant is requesting the transaction be underwritten by an underwriting institution.

Clause 4: The computer-implemented method of any of clauses 1-3, wherein receiving the underwriting response message comprising the indication as to whether the instant transaction is underwritten by the underwriting institution associated with an underwriting system comprises: receiving a plurality of underwriting response messages from a plurality of underwriting systems associated with a plurality of underwriting institutions, the underwriting response messages comprising underwriting data associated with the instant transaction; and selecting an underwriting system associated with an underwriting institution to underwrite the instant transaction based on data included in the underwriting response messages.

Clause 5: The computer-implemented method of any of clauses 1-4, wherein selecting the underwriting system associated with the underwriting institution to underwrite the instant transaction based on data included in the underwriting response messages comprises: comparing the data included in the underwriting response messages received from the plurality of underwriting systems; and selecting the underwriting system associated with a value for underwriting the instant transaction that is lower than values for underwriting the instant transaction associated with the other underwriting institutions from among the plurality of underwriting institutions.

Clause 6: The computer-implemented method of any of clauses 1-5, wherein selecting the underwriting system associated with the underwriting institution to underwrite the instant transaction based on data included in the underwriting response messages comprises: comparing the data included in the underwriting response messages received from the plurality of underwriting systems; and selecting the underwriting system associated with a period of time which may pass before satisfaction of the transaction by the underwriting institution is permitted, wherein the period of time is greater than periods of time which may pass associated with the other underwriting institutions from among the plurality of underwriting institutions

Clause 7: The computer-implemented method of any of clauses 1-6, further comprising: receiving, with at least one processor, a request message comprising a request for transaction identification data associated with an identifier of the instant transaction from the supplier system involved in the instant transaction; generating, with at least one processor, the transaction identification data associated with the identifier of the instant transaction; and transmitting, with at least one processor, the transaction identification data associated with the identifier of the instant transaction to the supplier system involved in the instant transaction.

Clause 8: The computer-implemented method of any of clauses 1-7, further comprising: receiving, with at least one processor, a request message comprising a request for transaction identification data associated with an identifier of the instant transaction from the supplier system involved in the instant transaction; generating, with at least one processor, the transaction identification data associated with the identifier of the instant transaction; and transmitting, with at least one processor, the transaction identification data associated with the identifier of the instant transaction to the merchant system involved in the instant transaction.

Clause 9: The computer-implemented method of any of clauses 1-8, wherein, transmitting the transaction identification data associated with the identifier of the instant transaction to the merchant system involved in the instant transaction comprises transmitting the transaction identification data associated with the identifier of the instant transaction via a data connection or an SMS connection.

Clause 10: The computer-implemented method of any of clauses 1-9, wherein, transmitting the transaction identification data associated with the identifier of the instant transaction to the merchant system involved in the instant transaction comprises transmitting the transaction identification data associated with the identifier of the instant transaction via an online portal associated with a webpage of a website.

Clause 11: The computer-implemented method of any of clauses 1-10, further comprising: receiving, with at least one processor, the transaction identification data associated with the identifier of the instant transaction from the merchant system; transmitting, with at least one processor, an authorization request message to an issuer system based on receiving the transaction identification data associated with the identifier of the instant transaction; receiving, with at least one processor, an authorization response message from the issuer system, the authorization response message comprising an indication as to whether the transaction is approved; and transmitting, with at least one processor, a confirmation message comprising an indication as to whether the instant transaction was successfully processed based on the indication as to whether the transaction is approved comprised in the authorization response message.

Clause 12: The computer-implemented method of any of clauses 1-11, wherein generating the transaction identification data associated with the identifier of the instant transaction comprises: generating, with at least one processor, the transaction identification data associated with the identifier of the instant transaction, the identifier comprising a computer-readable image associated with an account of the merchant maintained by the underwriting system.

Clause 13: The computer-implemented method of any of clauses 1-12, further comprising: receiving, with at least one processor, the transaction identification data associated with the identifier of the instant transaction from the merchant system, and receiving, with at least one processor, image data associated with an image received by the merchant system of a computer-readable image associated with an account of the merchant maintained by the underwriting system.

Clause 14: The computer-implemented method of any of clauses 1-13, wherein determining the score data associated with the credit score of the merchant based on the at least one transaction involving the merchant and the at least one supplier comprises: receiving merchant data associated with the merchant; and receiving local factor data associated with one or more local factors; and wherein determining the credit score of the merchant comprises determining the credit score of the merchant based on the merchant data associated with the merchant and the local factor data associated with the one or more local factors.

Clause 15: The computer-implemented method of any of clauses 1-14, wherein determining the score data associated with the credit score of the merchant based on the at least one transaction involving the merchant and the at least one supplier comprises: determining local weather data associated with an indication as to a state of the weather associated with a location of the merchant; and generating updated score data associated with an updated credit score based at least partially on the local weather data, wherein the underwriting request message comprises the updated score data associated with the updated credit score.

Clause 16: The computer-implemented method of any of clauses 1-15, wherein determining the credit score of the merchant based on the at least one transaction involving the merchant and the at least one supplier comprises: determining local transaction data associated with one or more transactions that occur within a predetermined distance from a location associated with the merchant; and generating updated score data associated with an updated credit score based at least partially on the one or more transactions that occur within a predetermined distance from the location associated with the merchant, wherein the underwriting request message comprises the updated score data associated with the updated credit score.

Clause 17: The computer-implemented method of any of clauses 1-16, wherein determining local transaction data associated with one or more transactions that occur within a predetermined distance from the location associated with the merchant comprises: receiving transaction data associated with one or more transactions involving another merchant associated with another merchant system and the at least one supplier associated with the at least one supplier system; and selecting transactions from the one or more transactions involving the another merchant associated with another merchant system and the at least one supplier associated with the at least one supplier system based on location data associated with the another merchant.

Clause 18: The computer-implemented method of any of clauses 1-17, wherein, when selecting transactions from the one or more transactions involving the another merchant associated with another merchant system and the at least one supplier associated with the at least one supplier system based on location data associated with the another merchant, the transactions that are selected comprise transactions associated with the another merchant that is located within a predetermined distance from the location of the merchant involved in the instant transaction.

Clause 19: A system, comprising: at least one processor programmed or configured to: receive transaction data associated with at least one transaction involving a merchant associated with a merchant system and at least one supplier associated with at least one supplier system; determine a credit score of the merchant based on the at least one transaction involving the merchant and the at least one supplier; receive transaction request data associated with an instant transaction involving the merchant associated with the merchant system and a supplier associated with a supplier system; transmit an underwriting request message comprising score data associated with the credit score of the merchant and the transaction request data associated with the instant transaction to at least one underwriting system associated with at least one underwriting institution; receive an underwriting response message comprising an indication as to whether the instant transaction is underwritten by an underwriting institution associated with an underwriting system; and transmit transaction response data associated with a transaction response to the supplier system, the transaction response comprising an indication as to whether the instant transaction is underwritten.

Clause 20: The system of clause 19, wherein the at least one processor is further programmed or configured to: determine that insufficient funds are available from an account associated with the merchant that is maintained by an issuer system associated with an issuer institution based on receiving the transaction request data associated with the instant transaction; and generate the underwriting request message based on determining that insufficient funds are available from the account associated with the merchant that is maintained by the issuer system.

Clause 21: The system of clauses 19 or 20, wherein the at least one processor is further programmed or configured to: determine that the transaction request data associated with the instant transaction indicates that the merchant is requesting the transaction be underwritten by an underwriting institution; and generate the underwriting request message based on determining that the transaction request data associated with the instant transaction indicates that the merchant is requesting the transaction be underwritten by an underwriting institution.

Clause 22: The system of any of clauses 19-21, wherein, when receiving the underwriting response message comprising the indication as to whether the instant transaction is underwritten by the underwriting institution associated with an underwriting system, the at least one processor is programmed or configured to: receive a plurality of underwriting response messages from a plurality of underwriting systems associated with a plurality of underwriting institutions, the underwriting response messages comprising underwriting data associated with the instant transaction; and select an underwriting system associated with an underwriting institution to underwrite the instant transaction based on data included in the underwriting response messages.

Clause 23: The system of any of clauses 19-22, wherein, when selecting the underwriting system associated with the underwriting institution to underwrite the instant transaction based on data included in the underwriting response messages, the at least one processor is programmed or configured to: compare the data included in the underwriting response messages received from the plurality of underwriting systems; and select the underwriting system associated with a value for underwriting the instant transaction that is lower than values for underwriting the instant transaction associated with the other underwriting institutions from among the plurality of underwriting institutions.

Clause 24: The system of any of clauses 19-23, wherein, when selecting the underwriting system associated with the underwriting institution to underwrite the instant transaction based on data included in the underwriting response messages, the at least one processor is programmed or configured to: compare the data included in the underwriting response messages received from the plurality of underwriting systems; and select the underwriting system associated with a period of time which may pass before satisfaction of the transaction by the underwriting institution is permitted, wherein the period of time is greater than periods of time which may pass associated with the other underwriting institutions from among the plurality of underwriting institutions.

Clause 25: The system of any of clauses 19-24, wherein the at least one processor is further programmed or configured to: receive a request message comprising a request for transaction identification data associated with an identifier of the instant transaction from the supplier system involved in the instant transaction; generate the transaction identification data associated with the identifier of the instant transaction; and transmit the transaction identification data associated with the identifier of the instant transaction to the supplier system involved in the instant transaction.

Clause 26: The system of any of clauses 19-25, wherein the at least one processor is further programmed or configured to: receive a request message comprising a request for transaction identification data associated with an identifier of the instant transaction from the supplier system involved in the instant transaction; generate the transaction identification data associated with the identifier of the instant transaction; and transmit the transaction identification data associated with the identifier of the instant transaction to the merchant system involved in the instant transaction.

Clause 27: The system of any of clauses 19-26, wherein, transmitting the transaction identification data associated with the identifier of the instant transaction to the merchant system involved in the instant transaction, the at least one processor is programmed or configured to transmit the transaction identification data associated with the identifier of the instant transaction via a data connection or an SMS connection.

Clause 28: The system of any of clauses 19-27, wherein, when transmitting the transaction identification data associated with the identifier of the instant transaction to the merchant system involved in the instant transaction, the at least one processor is programmed or configured to transmit the transaction identification data associated with the identifier of the instant transaction via an online portal associated with a webpage of a website.

Clause 29: The system of any of clauses 19-28, wherein the at least one processor is further programmed or configured to: receive the transaction identification data associated with the identifier of the instant transaction from the merchant system; transmit an authorization request message to an issuer system based on receiving the transaction identification data associated with the identifier of the instant transaction; receive an authorization response message from the issuer system, the authorization response message comprising an indication as to whether the transaction is approved; and transmit a confirmation message comprising an indication as to whether the instant transaction was successfully processed based on the indication as to whether the transaction is approved comprised in the authorization response message.

Clause 30: The system of any of clauses 19-29, wherein, when generating the transaction identification data associated with the identifier of the instant transaction, the at least one processor is programmed or configured to: generate the transaction identification data associated with the identifier of the instant transaction, the identifier comprising a computer-readable image associated with an account of the merchant maintained by the underwriting system.

Clause 31: The system of any of clauses 19-30, wherein the at least one processor is further programmed or configured to: receive the transaction identification data associated with the identifier of the instant transaction from the merchant system, and receive image data associated with an image received by the merchant system of a computer-readable image associated with an account of the merchant maintained by the underwriting system.

Clause 32: The system of any of clauses 19-31, wherein, when determining the score data associated with the credit score of the merchant based on the at least one transaction involving the merchant and the at least one supplier, the at least one processor is programmed or configured to: receive merchant data associated with the merchant; and receive local factor data associated with one or more local factors, wherein, when determining the credit score of the merchant, the at least one processor is programmed or configured to determine the credit score of the merchant based on the merchant data associated with the merchant and the local factor data associated with the one or more local factors.

Clause 33: The system of any of clauses 19-32, wherein, when determining the score data associated with the credit score of the merchant based on the at least one transaction involving the merchant and the at least one supplier, the at least one processor is programmed or configured to: determine local weather data associated with an indication as to a state of the weather associated with a location of the merchant; and generate updated score data associated with an updated credit score based at least partially on the local weather data, wherein the underwriting request message comprises the updated score data associated with the updated credit score.

Clause 34: The system of any of clauses 19-33, wherein, when determining the credit score of the merchant based on the at least one transaction involving the merchant and the at least one supplier, the at least one processor is programmed or configured to: determine local transaction data associated with one or more transactions that occur within a predetermined distance from a location associated with the merchant; and generate updated score data associated with an updated credit score based at least partially on the one or more transactions that occur within a predetermined distance from the location associated with the merchant, wherein the underwriting request message comprises the updated score data associated with the updated credit score.

Clause 35: The system of any of clauses 19-34, wherein, when determining local transaction data associated with one or more transactions that occur within a predetermined distance from the location associated with the merchant, the at least one processor is programmed or configured to: receive transaction data associated with one or more transactions involving another merchant associated with another merchant system and the at least one supplier associated with the at least one supplier system; and select transactions from the one or more transactions involving the another merchant associated with another merchant system and the at least one supplier associated with the at least one supplier system based on location data associated with the another merchant.

Clause 36: The system of any of clauses 19-35, wherein, when selecting transactions from the one or more transactions involving the another merchant associated with another merchant system and the at least one supplier associated with the at least one supplier system based on location data associated with the another merchant, the transactions that are selected comprise transactions associated with the another merchant that is located within a predetermined distance from the location of the merchant involved in the instant transaction.

Clause 37: A computer program product, comprising at least one non-transitory computer-readable medium comprising one or more instructions that, when executed by at least one processor, cause the at least one processor to: receive transaction data associated with at least one transaction involving a merchant associated with a merchant system and at least one supplier associated with at least one supplier system; determine a credit score of the merchant based on the at least one transaction involving the merchant and the at least one supplier; receive transaction request data associated with an instant transaction involving the merchant associated with the merchant system and a supplier associated with a supplier system; transmit an underwriting request message comprising score data associated with the credit score of the merchant and the transaction request data associated with the instant transaction to at least one underwriting system associated with at least one underwriting institution; receive an underwriting response message comprising an indication as to whether the instant transaction is underwritten by an underwriting institution associated with an underwriting system; and transmit transaction response data associated with a transaction response to the supplier system, the transaction response comprising an indication as to whether the instant transaction is underwritten.

Clause 38: The computer program product of clause 37, wherein the one or more instructions further cause the at least one processor to: determine that insufficient funds are available from an account associated with the merchant that is maintained by an issuer system associated with an issuer institution based on receiving the transaction request data associated with the instant transaction; and generate the underwriting request message based on determining that insufficient funds are available from the account associated with the merchant that is maintained by the issuer system.

Clause 39: The computer program product of clauses 37 or 38, wherein the one or more instructions further cause the at least one processor to: determine that the transaction request data associated with the instant transaction indicates that the merchant is requesting the transaction be underwritten by an underwriting institution; and generate the underwriting request message based on determining that the transaction request data associated with the instant transaction indicates that the merchant is requesting the transaction be underwritten by an underwriting institution.

Clause 40: The computer program product of any of clauses 37-39, wherein, the one or more instructions that cause the at least one processor to receive the underwriting response message comprising the indication as to whether the instant transaction is underwritten by the underwriting institution associated with an underwriting system, cause the at least one processor to: receive a plurality of underwriting response messages from a plurality of underwriting systems associated with a plurality of underwriting institutions, the underwriting response messages comprising underwriting data associated with the instant transaction; and select an underwriting system associated with an underwriting institution to underwrite the instant transaction based on data included in the underwriting response messages.

Clause 41: The computer program product of any of clauses 37-40, wherein, the one or more instructions that cause the at least one processor to select the underwriting system associated with the underwriting institution to underwrite the instant transaction based on data included in the underwriting response messages, cause the at least one processor to: compare the data included in the underwriting response messages received from the plurality of underwriting systems; and select the underwriting system associated with a value for underwriting the instant transaction that is lower than values for underwriting the instant transaction associated with the other underwriting institutions from among the plurality of underwriting institutions.

Clause 42: The computer program product of any of clauses 37-41, wherein, the one or more instructions that cause the at least one processor to select the underwriting system associated with the underwriting institution to underwrite the instant transaction based on data included in the underwriting response messages, cause the at least one processor to: compare the data included in the underwriting response messages received from the plurality of underwriting systems; and select the underwriting system associated with a period of time which may pass before satisfaction of the transaction by the underwriting institution is permitted, wherein the period of time is greater than periods of time which may pass associated with the other underwriting institutions from among the plurality of underwriting institutions.

Clause 43: The computer program product of any of clauses 37-42, wherein the one or more instructions further cause the at least one processor to: receive a request message comprising a request for transaction identification data associated with an identifier of the instant transaction from the supplier system involved in the instant transaction; generate the transaction identification data associated with the identifier of the instant transaction; and transmit the transaction identification data associated with the identifier of the instant transaction to the supplier system involved in the instant transaction.

Clause 44: The computer program product of any of clauses 37-43, wherein the one or more instructions further cause the at least one processor to: receive a request message comprising a request for transaction identification data associated with an identifier of the instant transaction from the supplier system involved in the instant transaction; generate the transaction identification data associated with the identifier of the instant transaction; and transmit the transaction identification data associated with the identifier of the instant transaction to the merchant system involved in the instant transaction.

Clause 45: The computer program product of any of clauses 37-44, wherein, the one or more instructions that cause the at least one processor to transmit the transaction identification data associated with the identifier of the instant transaction to the merchant system involved in the instant transaction cause the at least one processor to transmit the transaction identification data associated with the identifier of the instant transaction via a data connection or an SMS connection.

Clause 46: The computer program product of any of clauses 37-45, wherein, the one or more instructions that cause the at least one processor to transmit the transaction identification data associated with the identifier of the instant transaction to the merchant system involved in the instant transaction cause the at least one processor to transmit the transaction identification data associated with the identifier of the instant transaction via an online portal associated with a webpage of a website.

Clause 47: The computer program product of any of clauses 37-46, wherein the one or more instructions further cause the at least one processor to: receive the transaction identification data associated with the identifier of the instant transaction from the merchant system; transmit an authorization request message to an issuer system based on receiving the transaction identification data associated with the identifier of the instant transaction; receive an authorization response message from the issuer system, the authorization response message comprising an indication as to whether the transaction is approved; and transmit a confirmation message comprising an indication as to whether the instant transaction was successfully processed based on the indication as to whether the transaction is approved comprised in the authorization response message.

Clause 48: The computer program product of any of clauses 37-47, wherein, the one or more instructions that cause the at least one processor to generate the transaction identification data associated with the identifier of the instant transaction, cause the at least one processor to: generate the transaction identification data associated with the identifier of the instant transaction, the identifier comprising a computer-readable image associated with an account of the merchant maintained by the underwriting system.

Clause 49: The computer program product of any of clauses 37-48, wherein the one or more instructions further cause the at least one processor to: receive the transaction identification data associated with the identifier of the instant transaction from the merchant system, and receive image data associated with an image received by the merchant system of a computer-readable image associated with an account of the merchant maintained by the underwriting system.

Clause 50: The computer program product of any of clauses 37-49, wherein, the one or more instructions that cause the at least one processor to determine the score data associated with the credit score of the merchant based on the at least one transaction involving the merchant and the at least one supplier, cause the at least one processor to: receive merchant data associated with the merchant; and receive local factor data associated with one or more local factors, wherein, when determining the credit score of the merchant, the at least one processor is programmed or configured to determine the credit score of the merchant based on the merchant data associated with the merchant and the local factor data associated with the one or more local factors.

Clause 51: The computer program product of any of clauses 37-50, wherein, the one or more instructions that cause the at least one processor to determine the score data associated with the credit score of the merchant based on the at least one transaction involving the merchant and the at least one supplier, cause the at least one processor to: determine local weather data associated with an indication as to a state of the weather associated with a location of the merchant; and generate updated score data associated with an updated credit score based at least partially on the local weather data, wherein the underwriting request message comprises the updated score data associated with the updated credit score.

Clause 52: The computer program product of any of clauses 37-51, wherein, the one or more instructions that cause the at least one processor to determine the credit score of the merchant based on the at least one transaction involving the merchant and the at least one supplier, cause the at least one processor to: determine local transaction data associated with one or more transactions that occur within a predetermined distance from a location associated with the merchant; and generate updated score data associated with an updated credit score based at least partially on the one or more transactions that occur within a predetermined distance from the location associated with the merchant, wherein the underwriting request message comprises the updated score data associated with the updated credit score.

Clause 53: The computer program product of any of clauses 37-52, wherein, the one or more instructions that cause the at least one processor to determine local transaction data associated with one or more transactions that occur within a predetermined distance from the location associated with the merchant, cause the at least one processor to: receive transaction data associated with one or more transactions involving another merchant associated with another merchant system and the at least one supplier associated with the at least one supplier system; and select transactions from the one or more transactions involving the another merchant associated with another merchant system and the at least one supplier associated with the at least one supplier system based on location data associated with the another merchant.

Clause 54: The computer program product of any of clauses 37-53, wherein, the one or more instructions that cause the at least one processor to select transactions from the one or more transactions involving the another merchant associated with another merchant system and the at least one supplier associated with the at least one supplier system based on location data associated with the another merchant, the transactions that are selected comprising transactions associated with the another merchant that is located within a predetermined distance from the location of the merchant involved in the instant transaction.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

FIG. 1 is a diagram of a non-limiting aspect or embodiment of a system for tracking data associated with an account to determine a score;

FIG. 2 is a diagram of a non-limiting aspect or embodiment of components of one or more devices and/or one or more systems of FIG. 1;

FIG. 3 is a flowchart of a non-limiting aspect or embodiment of a process for tracking data associated with an account to determine a score;

FIG. 4 is a flowchart of a non-limiting aspect or embodiment of a process for processing a transaction; and

FIGS. 5A and 5B are a diagram of an implementation of a non-limiting aspect or embodiment of a process for tracking data associated with an account to determine a score.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth® communication receivers, near-field communication (NFC) receivers, radio frequency identification (RFID) receivers, and/or other contactless transceivers or receivers, contact-based receivers, payment terminals, and/or the like.

As used herein, the term “POS system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, AmericanExpress®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices that are configured to directly or indirectly communicate with or over one or more networks. In some non-limiting embodiments, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments, a computing device may include a server, a desktop computer, and/or the like.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as one or more POS devices used by a merchant. In some non-limiting embodiments, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments, computer-implemented methods, systems, and computer program products are disclosed. For example, computer-implemented methods as described herein may include receiving transaction data associated with at least one transaction involving a merchant and at least one supplier, determining a credit score of the merchant based on the at least one transaction involving the merchant and the at least one supplier, receiving transaction request data associated with an instant transaction involving the merchant and a supplier, transmitting an underwriting request message comprising score data associated with the credit score of the merchant and the transaction request data associated with the instant transaction to an issuer system, receiving an underwriting response message comprising an indication as to whether the instant transaction is underwritten by an issuer from the issuer system, and transmitting transaction response data associated with a transaction response to the supplier system, the transaction response comprising an indication as to whether the instant transaction is underwritten. By virtue of the above-noted features and embodiments described herein, underwriting institutions may receive data enabling the underwriting institutions to more accurately determine whether to approve or not approve a transaction. For example, underwriting institutions associated with underwriting systems, in addition to receiving data that may be included in an authorization request message such as data associated with the value of a transaction, data associated with the time and location at which the transaction is occurring, and/or the like, receive score data associated with a credit score of a party initiating a transaction (e.g., a merchant). The score data may be determined by a transaction service provider system prior to transmission to underwriting institutions, thereby reducing the amount of time and resources needed by the underwriting institutions to determine whether to underwrite the transaction. The transaction service provider system 110 may also periodically or continuously update the credit score, further reducing the amount of time needed during a transaction to prepare and transmit an authorization request message and, by extension, disperse funds and/or a guarantee of funds in the future transmitted from a transaction service provider system to a supplier system.

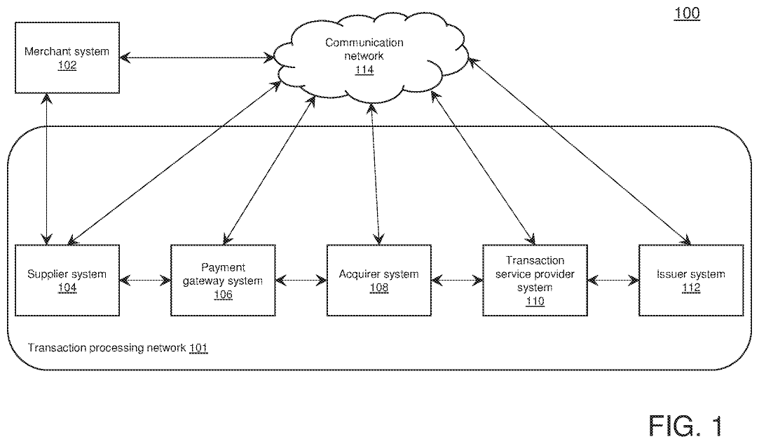

Referring now to FIG. 1, FIG. 1 is a diagram of an example environment 100 in which devices, systems, methods, and/or products described herein may be implemented. As shown in FIG. 1, environment 100 includes transaction processing network 101, merchant system 102, supplier system 104, payment gateway system 106, acquirer system 108, transaction service provider system 110, issuer system 112, and/or underwriting system 114. Transaction processing network 101, merchant system 102, supplier system 104, payment gateway system 106, acquirer system 108, transaction service provider system 110, issuer system 112, and/or underwriting system 114 may interconnect (e.g., establish a connection to communicate, and/or the like) via wired connections, wireless connections, or a combination of wired and wireless connections.

Merchant system 102 may include one or more devices capable of being in communication with supplier system 104, payment gateway system 106, acquirer system 108, transaction service provider system 110, issuer system 112, and/or underwriting system 114 via communication network 116. For example, merchant system 102 may include one or more payment devices, one or more computing devices, such as one or more mobile devices, one or more smartphones, one or more wearable devices (e.g., watches, glasses, lenses, clothing, and/or the like), one or more personal digital assistants (PDAs), one or more servers, and/or the like. In some non-limiting embodiments, merchant system 102 may communicate via a short-range wireless communication connection (e.g., a wireless communication connection for communicating information in a range between 2 to 3 centimeters to 5 to 6 meters, such as a near-field communication (NFC) communication connection, a radio frequency identification (RFID) communication connection, a Bluetooth® communication connection, and/or the like). In some non-limiting embodiments, merchant system 102 may be associated with a merchant, as described herein.

Supplier system 104 may include one or more devices capable of being in communication with merchant system 102, payment gateway system 106, acquirer system 108, transaction service provider system 110, issuer system 112, and/or underwriting system 114 via communication network 116. For example, supplier system 104 may include one or more computing devices, such as one or more mobile devices, one or more smartphones, one or more wearable devices, one or more servers, and/or the like. In some non-limiting embodiments, supplier system 104 may communicate via a short-range wireless communication connection. In some non-limiting embodiments, supplier system 104 may be associated with a supplier (e.g., one or more entities (e.g., distributors) that provide goods, services, and/or access to goods and/or services, to a merchant.

Payment gateway system 106 may include one or more devices capable of being in communication with merchant system 102, supplier system 104, acquirer system 108, transaction service provider system 110, issuer system 112, and/or underwriting system 114 via communication network 116. For example, payment gateway system 106 may include one or more computing devices, such one or more servers and/or other like devices. In some non-limiting embodiments, payment gateway system 106 may be associated with a payment gateway as described herein.

Acquirer system 108 may include one or more devices capable of being in communication with merchant system 102, supplier system 104, payment gateway system 106, transaction service provider system 110, issuer system 112, and/or underwriting system 114 via communication network 116. For example, acquirer system 108 may include one or more computing devices, such one or more servers and/or other like devices. In some non-limiting embodiments, acquirer system 108 may be associated with an acquirer as described herein.

Transaction service provider system 110 may include one or more devices capable of being in communication with merchant system 102, supplier system 104, payment gateway system 106, acquirer system 108, issuer system 112, and/or underwriting system 114 via communication network 116. For example, transaction service provider system 110 may include a server (e.g., a transaction processing server), a group of servers (e.g., a group of transaction processing servers), and/or other like devices. In some non-limiting embodiments, transaction service provider system 110 may be associated with a transaction service provider as described herein.

Issuer system 112 may include one or more devices capable of being in communication with merchant system 102, supplier system 104, payment gateway system 106, acquirer system 108, transaction service provider system 110, and/or underwriting system 114 via communication network 116. For example, issuer system 112 may include may include one or more computing devices, such one or more servers and/or other like devices. In some non-limiting embodiments, issuer system 112 may be associated with an issuer institution that issued a payment account and/or instrument (e.g., a credit account, a debit account, a credit card, a debit card, and/or the like) to a merchant (e.g., a merchant associated with merchant system 102).

Underwriting system 114 may include one or more devices capable of being in communication with merchant system 102, supplier system 104, payment gateway system 106, acquirer system 108, transaction service provider system 110, issuer system 112, and/or underwriting system 114 via communication network 116. For example, underwriting system 114 may include one or more computing devices, such as one or more servers and/or other like devices. In some non-limiting embodiments, underwriting system 114 may be associated with an underwriting institution that issued funds and/or a guarantee for funds to satisfy one or more transactions involving a merchant and one or more suppliers. In some non-limiting embodiments, underwriting system 114 may include and/or be included in supplier system 104, payment gateway system 106, acquirer system 108, transaction service provider system 110, issuer system 112, and/or a different issuer system.

In some non-limiting embodiments, transaction processing network 101 includes a plurality of systems in a communication path for processing a transaction. For example, transaction processing network 101 may include payment gateway system 106, acquirer system 108, transaction service provider system 110, issuer system 112, and/or underwriting system 114 in a communication path (e.g., a communication path, a communication channel, a communication network, and/or the like). As an example, transaction processing network 101 may process (e.g., initiate, conduct, authorize, and/or the like) an electronic payment transaction via the communication path between payment gateway system 106, acquirer system 108, transaction service provider system 110, issuer system 112, and/or underwriting system 114.

Communication network 116 may include one or more wired and/or wireless networks. For example, communication network 116 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of environment 100 may perform one or more functions described as being performed by another set of systems or another set of devices of environment 100.

In some non-limiting aspects or embodiments, transaction data may include transaction parameters associated with transactions, such as payment transactions initiated and/or conducted with an electronic wallet application, and/or the like. Non-limiting examples of transaction parameters include: electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a PIN, etc.), data associated with a transaction amount (e.g., an approved limit, a transaction value, etc.), data associated with a transaction date and time, data associated with a conversion rate of a currency, data associated with a merchant type (e.g., goods, grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

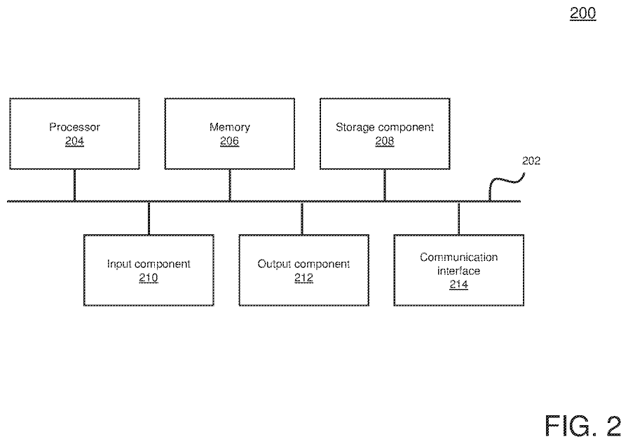

Referring now to FIG. 2, illustrated is a diagram of example components of device 200. Device 200 may correspond to one or more devices of transaction processing network 101, one or more devices of merchant system 102 (e.g., one or more devices of a system of merchant system 102), one or more devices of supplier system 104, one or more devices of the payment gateway system 106, one or more devices of acquirer system 108, one or more devices of transaction service provider system 110, one or more devices of the issuer system 112, and/or one or more devices of the communication network 116. In some non-limiting aspects or embodiments, one or more devices of merchant system 102, one or more devices of supplier system 104, one or more devices of payment gateway system 106, one or more devices of acquirer system 108, one or more devices of transaction service provider system 110, one or more devices of issuer system 112, and/or one or more devices of the communication network 116 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting aspects or embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting aspects or embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

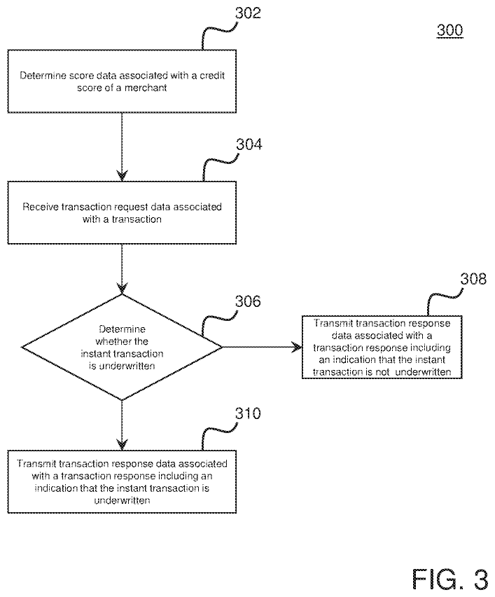

Referring now to FIG. 3, illustrated is a flowchart of a non-limiting aspect or embodiment of a process 300 for tracking data associated with an account to determine a score (e.g., a credit score). In some non-limiting aspects or embodiments, one or more of the functions described with respect to process 300 may be performed (e.g., completely, partially, etc.) by transaction service provider system 110. In some non-limiting embodiments, one or more of the steps of process 300 may be performed (e.g., completely, partially, and/or the like) by another device or a group of devices separate from and/or including transaction service provider system 110 such as, for example, merchant system 102, supplier system 104, payment gateway system 106, acquirer system 108, issuer system 112, another issuer system 112-1, and/or underwriting system 114.

As shown in FIG. 3, at step 302, process 300 may include determining a credit score of a merchant. For example, transaction service provider system 110 may determine a credit score of a merchant associated with merchant system 102. In some non-limiting embodiments, prior to and/or when determining the credit score of the merchant, transaction service provider system 110 may receive transaction data associated with at least one transaction involving the merchant and at least one supplier associated with at least one supplier system 104. Transaction service provider system 110 may then determine the credit score based on the one or more transactions involving the merchant associated with merchant system 102 and the at least one supplier associated with at least one supplier system 104 and/or based on data derived from the one or more transactions.

In some non-limiting embodiments, transaction service provider system 110 may determine the credit score to be a credit score within a range of possible credit scores (e.g., a score including an amount of points between 350 points and 850 points) based on merchant data associated with the merchant that is associated with merchant system 102. In one example, merchant data may include utilization data associated with a utilization ratio (e.g., a ratio of an amount of funds extended as credit and used by a merchant compared to an amount of funds extended as credit that are available to the merchant, an amount of funds extended and/or available to the merchant as credit compared to an amount of funds associated with the net revenue of the merchant, and/or the like). In another example, merchant data may include location data associated with a location (e.g., the location of a brick-and-mortar location of the merchant, data associated with a distance between the location of the merchant and one or more other brick-and-mortar locations of one or more other merchants, and/or the like). In yet another example, merchant data may include payment history data associated with a payment history of the merchant (e.g., how many transactions were paid on time, how many transactions were paid late, a ratio between the amount of transactions paid on time compared to the amount of transactions paid late, a ratio between the value of the transactions paid on time compared to the value of the transactions paid late, a volume of transactions and/or transaction values over a period of time, an amount of time taken to pay for each transaction from a point in time at which the transaction was initiated to a point in time at which the transaction was paid, and/or the like). In another example, merchant data may include transaction service provider data associated with a transaction service provider that services the merchant account associated with the merchant associated with merchant system 102. In an example, merchant data may include account history data associated with an account (e.g., a credit account, a debit account, and/or the like) maintained by issuer system 112 and/or underwriting system 114 on behalf of the merchant associated with merchant system 102 (e.g., an amount of time the account has been open). In yet another example, merchant data may include delinquency data associated with a number of months since the merchant associated with merchant system 102 was identified as delinquent.

In some non-limiting embodiments, transaction service provider system 110 may determine the credit score for the merchant based on a scoring model and the merchant data associated with the merchant. For example, transaction service provider system 110 may determine the credit score of the merchant associated with merchant system 102 based on the scoring model and the merchant data associated with the merchant by assigning an amount of points for each type of data associated with and/or included in the merchant data associated with the merchant. The amount of points assigned for each type of data associated with and/or included in the merchant data associated with the merchant may be weighted to increase and/or decrease the effect each type of data has when determining the credit score of the merchant associated with merchant system 102 (e.g., an overall credit score may be between a range of 350-850 points, with 20% of the score associated with the utilization ratio associated with the merchant, 5% of the score associated with the location of the merchant, 35% of the score associated with the payment history of the merchant, 5% of the score associated with the transaction service provider associated with the merchant, 15% of the score associated with an account associated with the merchant, and 20% of the score associated with a number of months since the merchant was identified as delinquent).

In one example, transaction service provider system 110 may assign a score of 160 points to the merchant associated with merchant system 102 where the utilization ratio is less than 10%, a score of 120 points where the utilization ratio is between 10% and 25%, a score of 100 points where the utilization ratio is between 25% and 40%, a score of 80 points where the utilization ratio is greater than 40%, and/or the like. In another example, transaction service provider system 110 may assign a score of 40 points to the merchant associated with merchant system 102 where the location of the merchant and one or more other brick-and-mortar locations of one or more other merchants is within a predetermined distance (e.g., where the merchant location is in a business district), a score of 30 points where the location of the merchant is less than 10 miles from the locations of one or more other merchants, a score of 20 points where the location of the merchant is between 10 miles and 20 miles of the locations of one or more other merchants, a score of 10 points where the location of the merchant is greater than 20 miles from the location of the one or more other merchants, and/or the like. In an example, transaction service provider system 110 may assign a score of 280 points where one or more transactions were paid on time by the merchant associated with merchant system 102, a score of 200 points where one or more transactions were paid between zero and two months after payment was due by the merchant, a score of 160 points where one or more transactions were paid between two and four months after payment was due by the merchant, a score of 140 points where one or more transactions were paid between four and six months after payment was due by the merchant, a score of 120 points where one or more transactions were paid more than six months after payment was due by the merchant, and/or the like. In another example, transaction service provider system 110 may assign a score of 40 points based on determining that a transaction service provider associated with transaction service provider system 110 and/or the transaction service provider associated with the account maintained by issuer system 112 on behalf of the merchant is a predetermined transaction service provider (e.g., Visa®, MasterCard®, AmericanExpress®, and/or the like) or may assign a score of 0 points where the transaction service provider is not a predetermined transaction service provider. In an example, transaction service provider system 110 may assign a score of 60 where account history data associated with an account maintained by issuer system 112 on behalf of the merchant associated with merchant system 102 includes an indication that the account has been open for less than a year, a score of 75 where the indication indicates that the account has been open for between 1 and 3 years, a score of 80 where the indication indicates that the account has been open for between 3 and 5 years, a score of 100 where the indication indicates that the account has been open for between 5 and 7 years, a score of 120 where the indication indicates that the account has been open for more than seven years, and/or the like. In an example, transaction service provider system 110 may assign a score of 160 where delinquency data associated with a number of months since the merchant associated with merchant system 102 was identified as delinquent includes an indication that the merchant is not delinquent, a score of 80 where the indication indicates that the merchant has been delinquent for between 0 and 6 months, a score of 60 where the indication indicates that the merchant has been delinquent for between 6 months and 1 year, a score of 40 where the indication indicates that the merchant has been delinquent for between greater than one year, and/or the like. In some or all of the above-noted examples, transaction service provider system 110 may determine the credit score of the merchant by combining the scores assigned for each type of data associated with the merchant.

In some non-limiting embodiments, transaction service provider system 110 may update the credit score periodically (e.g., once a day, once a week, and/or the like) and/or continuously (e.g., in response to receiving transaction data associated with an instant transaction and/or updated merchant data associated with the merchant, as discussed herein). By virtue of updating the score periodically and/or continuously, transaction service provider system 110 may reduce the amount of time needed to transmit an underwriting request message to underwriting system 114.

In some non-limiting embodiments, transaction service provider system 110 may determine and/or update the credit score of the merchant associated with merchant system 102 based on local factor data associated with one or more local factors, the one or more local factors associated with the merchant location. For example, transaction service provider system 110 may receive local factor data associated with the one or more local factors prior to or after receiving transaction request data associated with an instant transaction. Local factor data may include, without limitation, local weather data associated with an indication as to the state of the weather within a predetermined distance from the location associated with the merchant involved in the instant transaction (e.g., the state of the weather for a predetermined period of time such as, without limitation, one week, one month, six months, and/or the like), local transaction data associated with one or more transactions that occur within a predetermined distance from the location associated with the merchant, and/or the like. In some non-limiting embodiments, the local weather data associated with the indication as to the state of the weather within the predetermined distance from the location associated with the merchant involved in the instant transaction may be received from a remote system (e.g., a system maintained by the National Weather Service).

As shown in FIG. 3, at step 304, process 300 may include receiving transaction request data associated with an instant transaction (e.g., a transaction occurring after the transactions that were used to determine the credit score). For example, transaction service provider system 110 may receive transaction request data associated with the instant transaction, the instant transaction involving the merchant associated with merchant system 102 and a supplier associated with supplier system 104. In such an example, transaction service provider system 110 may receive the transaction request data associated with the instant transaction from supplier system 104. The supplier system 104 may transmit the transaction request data associated with the instant transaction based on (e.g., after) receiving the transaction request data associated with the instant transaction from merchant system 102. The transaction request data associated with the instant transaction may be associated with information for the instant transaction (e.g., an identifier of the merchant and/or the supplier associated with the instant transaction, a value of the instant transaction, a location associated with the instant transaction, an identifier of merchant system 102 and/or supplier system 104, an account identifier of an account associated with merchant system 102 that is maintained by issuer system 112, and/or the like). In some non-limiting embodiments, the transaction request data associated with the instant transaction may be associated with a request that the instant transaction be underwritten by an underwriting institution that lends funds to satisfy a transaction and/or guarantees that funds will be available to satisfy the transaction at a future point in time. In some non-limiting embodiments, the request that the instant transaction be underwritten by an underwriting institution associated with underwriting system 114 may cause transaction service provider system 110 to communicate with one or more systems that may underwrite the transaction (e.g., underwriting system 114, acquirer system 108, issuer system 112, another issuer system 112-1 that does not maintain an account on behalf of the merchant associated with merchant system 102, and/or the like), as described herein.

As shown in FIG. 3, at step 306, process 300 may include determining whether the instant transaction is underwritten. For example, transaction service provider system 110 may determine whether the instant transaction is underwritten. In such an example, transaction service provider system 110 may generate and transmit an underwriting request message to issuer system 112. In other examples, transaction service provider system 110 may generate and transmit the underwriting request message to acquirer system 108. The underwriting request message may include the score data associated with the credit score of the merchant, the transaction request data associated with the instant transaction, and/or data derived from either the score data associated with the credit score of the merchant and/or the transaction request data associated with the instant transaction. In some non-limiting embodiments, transaction service provider system 110 may generate and transmit the underwriting request message based on receiving the transaction request data associated with the instant transaction (e.g., from supplier system 104, and/or the like). In some non-limiting embodiments, transaction service provider system 110 may generate and transmit the underwriting request message to cause a system (e.g., issuer system 112, another issuer system 112-1 that does not maintain an account on behalf of the merchant associated with merchant system 102, and/or the like) to generate and transmit an underwriting response message, the underwriting response message including an indication indicating whether the transaction is underwritten. In an example, transaction service provider system 110 may generate and transmit the underwriting request message to multiple systems (e.g., issuer systems 112 associated with multiple issuer institutions) to cause the multiple systems to generate and transmit underwriting response messages to transaction service provider system 110.

In some non-limiting embodiments, transaction service provider system 110 may receive the underwriting response message. For example, transaction service provider system 110 may receive the underwriting response message from issuer system 112. In some non-limiting embodiments, the underwriting response message may include an indication as to whether the instant transaction is underwritten by an issuer institution associated with issuer system 112. For example, the underwriting response message may include an indication that indicates the instant transaction is underwritten (e.g., that funds will be available to satisfy the transaction at a predetermined period of time in the future after the point in time at which the underwriting response message is transmitted and/or after the point in time at which the issuer system 112 transmits a transaction response message including transaction response data associated with a transaction response indicating that the instant transaction is authorized by the issuer institution that indicated the instant transaction was underwritten). Alternatively, the underwriting response message may include an indication that indicates the instant transaction is not underwritten (e.g., that funds may not be available to satisfy the transaction at a predetermined period of time in the future from the issuer institution).

In some non-limiting embodiments, transaction service provider system 110 may determine whether the instant transaction is underwritten by the issuer institution based on the data included in the underwriting response message that is received from issuer system 112. Where transaction service provider system 110 determines the instant transaction is not underwritten by the issuer institution based on the data included in the underwriting response message received from issuer system 112, transaction service provider system 110 may transmit transaction response data associated with a transaction response including an indication that the instant transaction is not underwritten. Additionally, or alternatively, where transaction service provider system 110 determines the instant transaction is underwritten by the issuer institution based on the data included in the underwriting response message received from issuer system 112, transaction service provider system 110 may transmit transaction response data associated with a transaction response including an indication that the instant transaction is underwritten.

In some non-limiting embodiments, an underwriting response message may include underwriting data associated with the instant transaction. For example, transaction service provider system 110 may receive an underwriting response message including underwriting data associated with the instant transaction from one or more underwriting systems 114. The underwriting data associated with the instant transaction may include data associated with a value associated with underwriting the instant transaction, a period of time during which may pass before satisfaction of the transaction by the issuer institution and/or the acquirer institution that underwrote the instant transaction may occur, and/or the like. In some non-limiting embodiments, transaction service provider system 110 may determine that an underwriting system 114 is selected to underwrite the instant transaction based on receiving the underwriting data associated with the instant transaction. For example, transaction service provider system 110 may determine that underwriting system 114 is selected from among one or more underwriting systems 114 as associated with an underwriting institution that is selected to underwrite the instant transaction based on comparing the underwriting data associated with the instant transaction received from each of the underwriting systems 114 (e.g., the transaction service provider system 110 may determine that an underwriting system 114 from among the plurality of underwriting systems 114 is associated with a value associated with underwriting the instant transaction that is higher, lower, and/or equal to a value of another underwriting system 114, a period of time during which may pass before satisfaction of the transaction by the underwriting system 114 that is greater, less than, or equal to a period of time of another underwriting system 114, and/or the like).

As shown in FIG. 3, at step 308, process 300 may include transmitting transaction response data associated with a transaction response including an indication that the instant transaction is not underwritten. For example, transaction service provider system 110 may transmit the transaction response data associated with the transaction response including an indication that the instant transaction is not underwritten based on determining that one or more underwriting response messages received from one or more issuer systems 112 and/or one or more acquirer systems 108 include indications that the instant transaction is not underwritten. In another example, transaction service provider system 110 may transmit the transaction response data associated with the transaction response including an indication that the transaction is not underwritten based on determining that a transaction response message was not received from issuer system 112 and/or acquirer system 108, and as a result was not underwritten.

As shown in FIG. 3, at step 310, process 300 may include transmitting transaction response data associated with a transaction response including an indication that the instant transaction is underwritten. For example, transaction service provider system 110 may transmit the transaction response data associated with the transaction response including an indication that the transaction is underwritten based on determining that one or more underwriting response messages received from one or more issuer systems 112 and/or one or more acquirer systems 108 include indications that the instant transaction is underwritten to supplier system 104. In some non-limiting embodiments, transaction service provider system 110 may be associated with the instant transaction with an account associated with merchant system 102. For example, transaction service provider system 110 may be associated with the instant transaction with an account associated with merchant system 102 that is maintained by an issuer system 112 on behalf of the merchant associated with merchant system 102. Additionally, or alternatively, transaction service provider system 110 may be associated with the instant transaction with an account associated with merchant system 102 that is maintained by an issuer system 112 that maintains the account associated with merchant system 102 for underwriting the instant transaction.

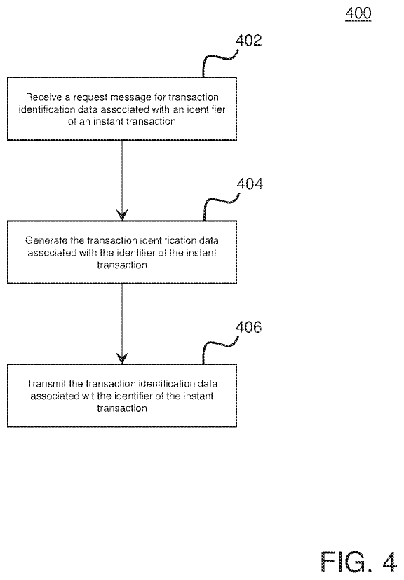

Referring now to FIG. 4, illustrated is a flowchart of a non-limiting aspect or embodiment of a process 400 for processing a transaction. In some non-limiting aspects or embodiments, one or more of the functions described with respect to process 400 may be performed (e.g., completely, partially, and/or the like) by transaction service provider system 110. In some non-limiting embodiments, one or more of the steps of process 400 may be performed (e.g., completely, partially, and/or the like) by another device or a group of devices separate from and/or including transaction service provider system 110, merchant system 102, supplier system 104, payment gateway system 106, acquirer system 108, and/or issuer system 112.

As shown in FIG. 4, at step 402, process 400 may include receiving a request message for transaction identification data associated with an identifier of an instant transaction. For example, transaction service provider system 110 may receive the request message for transaction identification data associated with the identifier of an instant transaction. In such an example, transaction service provider system 110 may receive the request message for transaction identification data associated with the identifier of an instant transaction from supplier system 104. In another example, transaction service provider system 110 may receive the request for transaction identification data associated with the identifier of the instant transaction from merchant system 102, issuer system 112 and/or acquirer system 108. In some non-limiting embodiments, transaction service provider system 110 may receive the request message for the transaction identification data associated with the identifier of the instant transaction before or after a period of time has elapsed, the period of time associated with the period of time before which transaction service provider system 110 may not request authorization for satisfaction of the instant transaction from a system that indicated that the instant transaction was underwritten (e.g., issuer system 112 and/or acquirer system 108). In some non-limiting embodiments, transaction service provider system 110 may receive the request message via a webpage (e.g., an online portal) associated with a website. For example, transaction service provider system 110 may host a website associated with the webpage, which may be accessed by merchant system 102, supplier system 104, acquirer system 108, and/or issuer system 112, to enable the systems to transmit a request message for the transaction identification data associated with the identifier of the instant transaction.

As shown in FIG. 4, at step 404, process 400 may include generating the transaction identification data associated with the identifier of the instant transaction. For example, transaction service provider system 110 may generate the transaction identification data associated with the identifier of the instant transaction. In doing so, transaction service provider system 110 may determine the identifier of the instant transaction and/or may lookup the identifier of the instant transaction (e.g., from the memory of transaction service provider system 110, from a database in communication with transaction service provider system 110, and/or the like). In some non-limiting embodiments, when determining the identifier of the instant transaction, transaction service provider system 110 may generate a computer-readable image (e.g., a barcode, a matrix barcode such as a Quick Response Code or QR code, and/or the like) that is associated with the instant transaction. In some non-limiting embodiments, the identifier of the instant transaction may be associated with an account of a merchant associated with merchant system 102. For example, transaction service provider system 110 may determine an account identifier that is associated with the instant transaction (e.g., an account identifier that identifies an account maintained by issuer system 112 and/or an account identifier that identifies an account maintained by issuer system 112 and/or acquirer system 108 that transmitted an underwriting response message indicating that the instant transaction was underwritten by the issuer institution associated with issuer system 112).

As shown in FIG. 4, at step 406, process 400 may include transmitting the transaction identification data associated with the identifier of the instant transaction. For example, transaction service provider system 110 may transmit the transaction identification data associated with the identifier of the instant transaction. In such an example, transaction service provider system 110 may transmit the transaction identification data associated with the identifier of the instant transaction after generating the transaction identification data associated with the identifier of the instant transaction. In one example, transaction service provider system 110 may transmit the transaction identification data associated with the identifier of the instant transaction to supplier system 104. In another example, transaction service provider system 110 may transmit the transaction identification data associated with the identifier of the instant transaction to issuer system 112, acquirer system 108, and/or merchant system 102. In examples where transaction service provider system 110 transmits the transaction identification data associated with the identifier of the instant transaction to supplier system 104, supplier system 104 may transmit the transaction identification data associated with the identifier of the instant transaction to merchant system 102 to cause merchant system 102 to initiate an electronic payment transaction for the instant transaction. In some non-limiting embodiments, the transaction identification data associated with the identifier of the instant transaction may be transmitted as part of a message (e.g., an email message, a message delivered via an application executed on a device such as merchant system 102, a message delivered via an online portal, and/or the like).

In some non-limiting embodiments, merchant system 102 may initiate the electronic payment transaction by transmitting the transaction identification data associated with the identifier of the instant transaction. For example, merchant system 102 may initiate the electronic payment transaction by transmitting the transaction identification data associated with the identifier of the instant transaction to transaction service provider system 110. In some non-limiting embodiments, merchant system 102 may generate and transmit a transaction initiation message to initiate an electronic payment transaction. For example, merchant system 102 may generate and transmit a transaction initiation message to initiate an electronic payment transaction to transaction service provider system 110, the transaction initiation message including an indication that the instant transaction is authorized by the merchant for settlement, the transaction identification data associated with the instant transaction, and/or the like.

In some non-limiting embodiments, transaction service provider system 110 may generate an authorization request message during an electronic payment transaction. For example, transaction service provider system 110 may generate an authorization request message based on receiving transaction identification data associated with the identifier of the instant transaction from merchant system 102. In another example, transaction service provider system 110 may generate an authorization request message based on receiving the transaction initiation message from merchant system 102. In some non-limiting embodiments, the authorization request message may include data associated with a value of the instant transaction, transaction identification data associated with an identifier of the instant transaction, and/or account identifying data associated with an account identifier associated with an account maintained by issuer system 112, the account identifier associated with merchant system 102. In some non-limiting embodiments, transaction service provider system 110 may determine the account identifier based on the identifier of the instant transaction. For example, transaction service provider system 110 may determine the account identifier based on the identifier of the instant transaction by looking up the account identifier in a database and/or by extracting the account identifier from the identifier of the instant transaction (e.g., by identifying a portion of the account identifier such as a region of a QR code that is associated with the account identifier of the merchant system 102).

In some non-limiting embodiments, transaction service provider system 110 may transmit the authorization request message. For example, transaction service provider system 110 may transmit the authorization request message to issuer system 112 that maintains an account on behalf of the merchant associated with merchant system 102. In such an example, transaction service provider system 110 may transmit the authorization request message to issuer system 112 to cause issuer system 112 to transmit an authorization response message, the authorization response message including an indication as to whether the transaction is approved or not approved. After transmitting the authorization request message, transaction service provider system 110 may receive the authorization response message, the authorization response message including the indication as to whether the transaction is approved or not approved. Where the indicator of the authorization response message indicates that the transaction is approved, transaction service provider system 110 may transmit a confirmation message to merchant system 102 and/or supplier system 104 indicating that the transaction was successfully processed (e.g., that the instant transaction was approved by issuer system 112 and/or underwriting system 114). Additionally, or alternatively, where the indicator of the authorization response message indicates that the transaction is not approved, transaction service provider system 110 may transmit a confirmation message to merchant system 102 and/or supplier system 104 indicating that the transaction was not successfully processed (e.g., that the instant transaction was not approved by issuer system 112 and/or underwriting system 114).

In some non-limiting embodiments, transaction service provider system 110 may generate and transmit a supplemental authorization request message. For example, transaction service provider system 110 may generate and transmit a supplemental authorization request message based on determining that the instant transaction was not approved by the issuer system 112. In some non-limiting embodiments, the supplemental authorization request message may include data associated with the value of the instant transaction, transaction identification data associated with an identifier of the instant transaction, and/or account identifying data associated an account identifier. In some non-limiting embodiments, transaction service provider system 110 may transmit the supplemental authorization request message to a system that indicated the instant transaction was underwritten (e.g., an issuer system 112 that indicated the instant transaction was underwritten the same as or different from the issuer system 112 that transmit the authorization response message not approving the instant transaction, acquirer system 108, and/or the like).

In some non-limiting embodiments, transaction service provider system 110 may receive a supplemental authorization response message including an indication as to whether the instant transaction is approved or not approved. For example, transaction service provider system 110 may receive a supplemental authorization response message including an indication as to whether the instant transaction is approved or not approved, a system that indicated the instant transaction was underwritten. In examples where the supplemental authorization response message includes an indication indicating that the instant transaction is approved, transaction service provider system 110 may generate and transmit a supplemental confirmation message including an indication that the instant transaction was processed successfully. In examples where the supplemental authorization response message includes an indication indicating that the instant transaction is not approved, transaction service provider system 110 may generate and transmit a supplemental confirmation message including an indication that the instant transaction was not processed successfully. For example, issuer system 112 may receive the supplemental authorization request message and determine that the period of time associated with processing the instant transaction with the system that indicated the instant transaction was underwritten did not elapse based on data included in the supplemental authorization request message and/or that issuer system 112 did not transmit an underwriting response message for the instant transaction indicating that the instant transaction was underwritten. In such an example, issuer system 112 may generate and transmit a supplemental authorization response message indicating that the instant transaction was not approved.

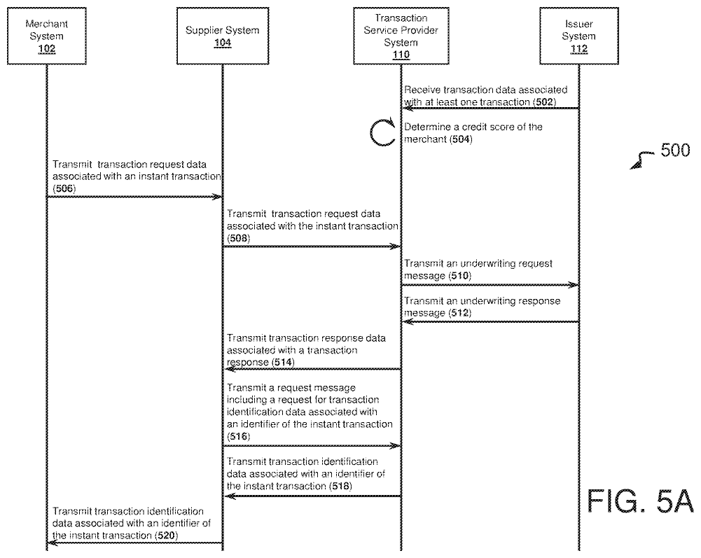

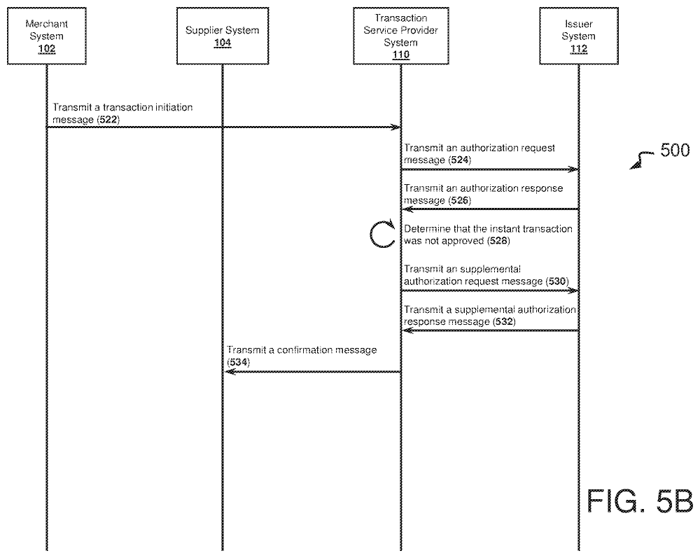

Referring now to FIG. 5A, illustrated is a flowchart of a non-limiting aspect or embodiment of an implementation 500 relating to a process tracking data associated with an account to determine a score. As illustrated in FIG. 5A, implementation 500 includes merchant system 102, supplier system 104, transaction service provider system 110, and underwriting system 114.

As shown by reference number 502 in FIG. 5A, transaction service provider system 110 may receive transaction data associated with at least one transaction involving merchant system 102 and one or more supplier systems 104. For example, transaction service provider system 110 may receive the transaction data associated with the at least one transaction prior to receiving transaction request data associated with an instant transaction from supplier system 104. In another example, transaction service provider system 110 may receive the transaction data associated with the at least one transaction based on receiving transaction request data associated with an instant transaction from supplier system 104.

As shown by reference number 504 in FIG. 5A, transaction service provider system 110 may determine a credit score of the merchant associated with merchant system 102. For example, transaction service provider system 110 may determine the credit score of the merchant associated with merchant system 102 based on receiving transaction data associated with at least one transaction involving the merchant associated with merchant system 102 and one or more suppliers associated with one or more supplier systems 104, merchant data associated with the merchant from one or more issuer systems 112, and/or data derived from the transaction data associated with the at least one transaction and/or the merchant data associated with the merchant. In an example, a credit score may be determined by transaction service provider system 110 as follows: a utilization ratio of $15,000 in used credit spread across accounts maintained by three suppliers (e.g., Supplier A may maintain an account associated with a $10,000 balance, Supplier B may maintain an account associated with a $3,000 balance, and Supplier C may maintain an account associated with a $2,000 balance) compared to $100,000 in revenue may be determined to be 15% and, subsequently, a score of 120 may be assigned based on the utilization ratio, the merchant location may be set in Manhattan, N.Y. and, subsequently, a score of 40 may be assigned based on the merchant location, the payment history of the merchant may include transactions that were all paid on time and, subsequently, a score of 280 may be assigned based on the payment history, the transaction service provider may be a predetermined transaction service provider and, subsequently, a score of 40 may be assigned, an account of the merchant associated with merchant system 102 may be determined to be three years old and, subsequently, a score of 80 may be assigned, and a number of months during which the merchant was identified as delinquent may be equal to zero and, subsequently, a score of 160 may be assigned. In the above-noted example, transaction service provider system 110 may add the scores assigned to determine a credit score of 720 points. In some non-limiting embodiments, transaction service provider system 110 may execute one or more applications associated with a customer relationship management (CRM) system. For example, transaction service provider system 110 may generate one or more reports based on determining one or more scores for one or more merchants associated with one or more merchant systems 102 (e.g., a report including data associated with an amount of records available compared to merchant scores and/or score ranges).

As shown by reference number 506 in FIG. 5A, merchant system 102 may transmit transaction request data associated with an instant transaction to supplier system 104. For example, merchant system 102 may transmit transaction request data associated with an instant transaction to supplier system 104 to initiate the instant transaction. As shown by reference number 508 in FIG. 5, supplier system 104 may transmit the transaction request data associated with the instant transaction to transaction service provider system 110.

As shown by reference number 510 in FIG. 5A, transaction service provider system 110 may transmit an underwriting request message to underwriting system 114. For example, transaction service provider system 110 may transmit the underwriting request message to underwriting system 114 (e.g., an underwriting system 114, an issuer system 112 that maintains an account on behalf of the merchant associated with merchant system 102, a different issuer system 112 that may or may not maintain an account on behalf of the merchant associated with merchant system 102, and/or the like). Transaction service provider system 110 may transmit the underwriting request message to underwriting system 114 to cause underwriting system 114 to transmit an underwriting response message.

As shown by reference number 512 in FIG. 5A, underwriting system 114 may transmit an underwriting response message to transaction service provider system 110. The underwriting response message may include an indication as to whether the transaction is underwritten by underwriting system 114.

As shown by reference number 514 in FIG. 5A, transaction service provider system 110 may transmit transaction response data associated with a transaction response for the instant transaction to supplier system 104. For example, transaction service provider system 110 may determine whether the instant transaction is underwritten and, based on determining whether the instant transaction is underwritten, may generate transaction response data associated with a transaction response including an indication as to whether the instant transaction is underwritten.

As shown by reference number 516 in FIG. 5A, supplier system 104 may transmit a request message including a request for transaction identification data associated with an identifier of the instant transaction. For example, supplier system 104 may determine that payment on the instant transaction that was guaranteed by underwriting system 114 is due, and may transmit the request message to cause transaction service provider system 110 to generate and/or transmit the transaction identification data associated with the identifier of the instant transaction. To transmit the request message, supplier system 104 may receive input to login to an online portal via a webpage, the webpage associated with a website hosted by transaction service provider system 110. The webpage may illustrate one or more merchants associated with merchant system 102 that purchased from the supplier associated with supplier system 104, the one or more merchants' contact information, a balance associated with the one or more merchants, an indication as to whether the balance is paid, a payment due date associated with the merchant, and/or the like. Supplier system 104 may then receive input (e.g., selection of a button) identifying the instant transaction and transmit the input to transaction service provider system 110 via the webpage.

As shown by reference number 518 in FIG. 5A, transaction service provider system 110 may transmit the transaction identification data associated with the identifier of the instant transaction to supplier system 104. For example, transaction service provider system 110 may transmit the transaction identification data associated with the identifier of the instant transaction to supplier system 104 based on receiving the request message including the request for the transaction identification data from supplier system 104. The identifier of the instant transaction may include a computer-readable image generated by transaction service provider system 110. Additionally, or alternatively, the identifier of the instant transaction may include a computer-readable image received from a remote computing device via an application programming interface (API). In some non-limiting embodiments, upon receipt of the transaction identification data associated with the identifier of the instant transaction, supplier system 104 may transmit the transaction identification data, data derived from the transaction identification data, and/or a message including the transaction identification data to merchant system 102 to cause merchant system 102 to initiate an electronic payment transaction associated with the instant transaction. In some non-limiting embodiments, the transaction identification data associated with the instant transaction may be transmitted from transaction service provider system 110 to supplier system 104 via a message, electronic mail, an SMS message, an MMS message including image data associated with the identifier of the instant transaction, and/or the like.

As shown by reference number 520 in FIG. 5A, supplier system 104 may transmit the transaction identification data associated with the identifier of the instant transaction to merchant system 102. For example, supplier system 104 may transmit the transaction identification data associated with the identifier of the instant transaction to merchant system 102 to cause merchant system 102 to initiate an electronic payment transaction associated with the instant transaction. In some non-limiting embodiments, the transaction identification data associated with the instant transaction may be transmitted from supplier system 104 to merchant system 102 via a message, electronic mail, an SMS message, an MMS message including image data associated with the identifier of the instant transaction, and/or the like.

As shown by reference number 522 in FIG. 5A, merchant system 102 may transmit a transaction initiation message to transaction service provider system 110 to initiate an electronic payment transaction associated with the instant transaction. The transaction initiation message may include the transaction identification data associated with the instant transaction and/or data derived from the transaction identification data (e.g., image data associated with an image of the computer-readable image) and/or an indication as to what the value of the transaction is approved for (e.g., some or all of the balance).

As shown by reference number 524 in FIG. 5B, transaction service provider system 110 may transmit an authorization request message to issuer system 112. For example, transaction service provider system 110 may transmit an authorization request message to issuer system 112, where issuer system 112 is the issuer system 112 maintaining an account associated with the merchant associated with merchant system 102. The authorization request message may include data associated with a value of the instant transaction, transaction identification data associated with an identifier of the instant transaction, and/or account identifying data associated with an account identifier associated with an account maintained by issuer system 112, and/or the account identifier associated with merchant system 102. As shown by reference number 526 in FIG. 5B, issuer system 112 may transmit an authorization response message including an indication as to whether the transaction is approved or is not approved. In some non-limiting embodiments, where the indication included in the authorization response message indicates that the transaction is approved, transaction service provider system 110 may generate and transmit a confirmation message including an indication that the instant transaction was successfully processed to supplier system 104 and/or merchant system 102.

As shown by reference number 528 in FIG. 5B, transaction service provider system 110 may determine that the instant transaction was not approved based on data included in the authorization response message. In such an example, as shown by reference number 530 in FIG. 5B, transaction service provider system 110 may transmit a supplemental authorization request message to underwriting system 114 requesting the instant transaction be authorized, where underwriting system 114 is the system that indicated the instant transaction was underwritten. As shown by reference number 532 in FIG. 5B, issuer system 112 may transmit a supplemental authorization response message including an indication as to whether the instant transaction is approved or not approved. In examples where the instant transaction is approved, as shown by reference number 534 in FIG. 5B, transaction service provider system 110 may transmit a confirmation message including an indication that the transaction was successfully processed to supplier system 104. In another example, where the instant transaction is approved, transaction service provider system 110 may transmit a confirmation message including an indication that the transaction was successfully processed to merchant system 102.

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, transaction data associated with at least one transaction involving a merchant associated with a merchant system and at least one supplier associated with at least one supplier system;
determining, with at least one processor, a credit score of the merchant based on the at least one transaction involving the merchant and the at least one supplier;
receiving, with at least one processor, transaction request data associated with an instant transaction involving the merchant associated with the merchant system and a supplier associated with a supplier system;
transmitting, with at least one processor, an underwriting request message comprising score data associated with the credit score of the merchant and the transaction request data associated with the instant transaction to at least one underwriting system associated with at least one underwriting institution;
receiving, with at least one processor, an underwriting response message comprising an indication as to whether the instant transaction is underwritten by an underwriting institution associated with an underwriting system; and
transmitting, with at least one processor, transaction response data associated with a transaction response to the supplier system, the transaction response comprising an indication as to whether the instant transaction is underwritten.

2. The computer-implemented method of claim 1, further comprising:
determining, with at least one processor, that insufficient funds are available from an account associated with the merchant that is maintained by an issuer system associated with an issuer institution based on receiving the transaction request data associated with the instant transaction; and
generating, with at least one processor, the underwriting request message based on determining that insufficient funds are available from the account associated with the merchant that is maintained by the issuer system.

3. The computer-implemented method of claim 1, further comprising:
determining, with at least one processor, that the transaction request data associated with the instant transaction indicates that the merchant is requesting the transaction be underwritten by an underwriting institution; and
generating, with at least one processor, the underwriting request message based on determining that the transaction request data associated with the instant transaction indicates that the merchant is requesting the transaction be underwritten by an underwriting institution.

4. The computer-implemented method of claim 1, wherein receiving the underwriting response message comprising the indication as to whether the instant transaction is underwritten by the underwriting institution associated with an underwriting system comprises:
receiving a plurality of underwriting response messages from a plurality of underwriting systems associated with a plurality of underwriting institutions, the underwriting response messages comprising underwriting data associated with the instant transaction; and
selecting an underwriting system associated with an underwriting institution to underwrite the instant transaction based on data included in the underwriting response messages.

5. The computer-implemented method of claim 4, wherein selecting the underwriting system associated with the underwriting institution to underwrite the instant transaction based on data included in the underwriting response messages comprises:
comparing the data included in the underwriting response messages received from the plurality of underwriting systems; and
selecting the underwriting system associated with a value for underwriting the instant transaction that is lower than values for underwriting the instant transaction associated with the other underwriting institutions from among the plurality of underwriting institutions.

6. The computer-implemented method of claim 4, wherein selecting the underwriting system associated with the underwriting institution to underwrite the instant transaction based on data included in the underwriting response messages comprises:
comparing the data included in the underwriting response messages received from the plurality of underwriting systems; and
selecting the underwriting system associated with a period of time which may pass before satisfaction of the transaction by the underwriting institution is permitted, wherein the period of time is greater than periods of time which may pass associated with the other underwriting institutions from among the plurality of underwriting institutions

7. The computer-implemented method of claim 1, further comprising:
receiving, with at least one processor, a request message comprising a request for transaction identification data associated with an identifier of the instant transaction from the supplier system involved in the instant transaction;
generating, with at least one processor, the transaction identification data associated with the identifier of the instant transaction; and
transmitting, with at least one processor, the transaction identification data associated with the identifier of the instant transaction to the supplier system involved in the instant transaction.

8. The computer-implemented method of claim 1, further comprising:
receiving, with at least one processor, a request message comprising a request for transaction identification data associated with an identifier of the instant transaction from the supplier system involved in the instant transaction;
generating, with at least one processor, the transaction identification data associated with the identifier of the instant transaction; and
transmitting, with at least one processor, the transaction identification data associated with the identifier of the instant transaction to the merchant system involved in the instant transaction.

9. The computer-implemented method of claim 8, wherein, transmitting the transaction identification data associated with the identifier of the instant transaction to the merchant system involved in the instant transaction comprises transmitting the transaction identification data associated with the identifier of the instant transaction via a data connection or an SMS connection.

10. The computer-implemented method of claim 8, wherein, transmitting the transaction identification data associated with the identifier of the instant transaction to the merchant system involved in the instant transaction comprises transmitting the transaction identification data associated with the identifier of the instant transaction via an online portal associated with a webpage of a website.

11. The computer-implemented method of claim 7, further comprising:
receiving, with at least one processor, the transaction identification data associated with the identifier of the instant transaction from the merchant system;
transmitting, with at least one processor, an authorization request message to an issuer system based on receiving the transaction identification data associated with the identifier of the instant transaction;
receiving, with at least one processor, an authorization response message from the issuer system, the authorization response message comprising an indication as to whether the transaction is approved; and
transmitting, with at least one processor, a confirmation message comprising an indication as to whether the instant transaction was successfully processed based on the indication as to whether the transaction is approved comprised in the authorization response message.

12. The computer-implemented method of claim 7, wherein generating the transaction identification data associated with the identifier of the instant transaction comprises:
generating, with at least one processor, the transaction identification data associated with the identifier of the instant transaction, the identifier comprising a computer-readable image associated with an account of the merchant maintained by the underwriting system.

13. The computer-implemented method of claim 11, further comprising:
receiving, with at least one processor, the transaction identification data associated with the identifier of the instant transaction from the merchant system, and
receiving, with at least one processor, image data associated with an image received by the merchant system of a computer-readable image associated with an account of the merchant maintained by the underwriting system.

14. The computer-implemented method of claim 1, wherein determining the score data associated with the credit score of the merchant based on the at least one transaction involving the merchant and the at least one supplier comprises:
receiving merchant data associated with the merchant; and
receiving local factor data associated with one or more local factors; and
wherein determining the credit score of the merchant comprises determining the credit score of the merchant based on the merchant data associated with the merchant and the local factor data associated with the one or more local factors.

15. The computer-implemented method of claim 1, wherein determining the score data associated with the credit score of the merchant based on the at least one transaction involving the merchant and the at least one supplier comprises:
determining local weather data associated with an indication as to a state of the weather associated with a location of the merchant; and
generating updated score data associated with an updated credit score based at least partially on the local weather data,
wherein the underwriting request message comprises the updated score data associated with the updated credit score.

16. The computer-implemented method of claim 1, wherein determining the credit score of the merchant based on the at least one transaction involving the merchant and the at least one supplier comprises:
determining local transaction data associated with one or more transactions that occur within a predetermined distance from a location associated with the merchant; and
generating updated score data associated with an updated credit score based at least partially on the one or more transactions that occur within a predetermined distance from the location associated with the merchant,
wherein the underwriting request message comprises the updated score data associated with the updated credit score.

17. The computer-implemented method of claim 16, wherein determining local transaction data associated with one or more transactions that occur within a predetermined distance from the location associated with the merchant comprises:
receiving transaction data associated with one or more transactions involving another merchant associated with another merchant system and the at least one supplier associated with the at least one supplier system; and
selecting transactions from the one or more transactions involving the another merchant associated with another merchant system and the at least one supplier associated with the at least one supplier system based on location data associated with the another merchant.

18. The computer-implemented method of claim 17, wherein, when selecting transactions from the one or more transactions involving the another merchant associated with another merchant system and the at least one supplier associated with the at least one supplier system based on location data associated with the another merchant, the transactions that are selected comprise transactions associated with the another merchant that is located within a predetermined distance from the location of the merchant involved in the instant transaction.

19. A system, comprising:
at least one processor programmed or configured to:
receive transaction data associated with at least one transaction involving a merchant associated with a merchant system and at least one supplier associated with at least one supplier system;
determine a credit score of the merchant based on the at least one transaction involving the merchant and the at least one supplier;
receive transaction request data associated with an instant transaction involving the merchant associated with the merchant system and a supplier associated with a supplier system;
transmit an underwriting request message comprising score data associated with the credit score of the merchant and the transaction request data associated with the instant transaction to at least one underwriting system associated with at least one underwriting institution;
receive an underwriting response message comprising an indication as to whether the instant transaction is underwritten by an underwriting institution associated with an underwriting system; and
transmit transaction response data associated with a transaction response to the supplier system, the transaction response comprising an indication as to whether the instant transaction is underwritten.

20. A computer program product comprising at least one non-transitory computer-readable medium comprising one or more instructions that, when executed by at least one processor, cause the at least one processor to:
receive transaction data associated with at least one transaction involving a merchant associated with a merchant system and at least one supplier associated with at least one supplier system;
determine a credit score of the merchant based on the at least one transaction involving the merchant and the at least one supplier;
receive transaction request data associated with an instant transaction involving the merchant associated with the merchant system and a supplier associated with a supplier system;
transmit an underwriting request message comprising score data associated with the credit score of the merchant and the transaction request data associated with the instant transaction to at least one underwriting system associated with at least one underwriting institution;
receive an underwriting response message comprising an indication as to whether the instant transaction is underwritten by an underwriting institution associated with an underwriting system; and
transmit transaction response data associated with a transaction response to the supplier system, the transaction response comprising an indication as to whether the instant transaction is underwritten.
